(19) United States
(12) Patent Application Publication
(10) Pub. No.: US 2023/0078389 A1
(43) Pub. Date: Mar. 16, 2023

(54) Computer Systems and Methods for Generating Predictive Change Events

(71) Applicant: Procore Technologies, Inc., Carpinteria, CA (US)

(72) Inventors: Catherine Knuff, Brooklyn, NY (US); James Adam Pita, Middletown, MD (US); Joshua Joel Morris, Torrance, CA (US); Ryan Christopher Huber, Santa Barbara, CA (US)

(21) Appl. No.: 17/474,787

(22) Filed: Sep. 14, 2021

(51) Int. Cl. G06Q 10/06; G06N 5/04; G06N 5/02

(52) U.S. Cl. CPC G06Q 10/06313; G06N 5/04; G06N 5/022

(57) ABSTRACT

A computing system is configured to receive a request to create a new change event for a construction project; obtain a set of initial information about the new change event; evaluate the set of initial information using predictive analytics and thereby predict one or more scopes of work that are likely implicated by the new change event, wherein each of the one or more scopes of work comprises a category of work activity and an estimated cost of performing the work activity; cause a client station to present the one or more scopes of work that are likely implicated by the new change event; receive data indicating that the user has selected at least one given scope of work from the one or more scopes of work; and create a data item that represents the new change event and includes data defining the at least one given scope of work.

### BACKGROUND

Managing a project from inception to completion can be a complex endeavor. Some projects, such as construction projects, can be highly complex, involving a large number of moving pieces that must work together effectively and efficiently to ensure that the project is successful.

Construction projects can be massive endeavors involving multiple different parties that need to collaborate throughout the course of the construction project on many different aspects. For instance, there may be a client who is funding the project (e.g., a project owner), a general contractor (“GC”) who manages the overall construction project, and numerous subcontractors (e.g., vendors, suppliers, etc.) who provide goods and/or services to the GC to complete the project. Typically, a project owner may enter into a “prime contract” with a GC that defines the overall scope of the work to be performed on the construction project and the fees that the project owner will pay to the GC in connection with that work. In turn, a GC may enter into various subcontracts with different subcontractors to work on different aspects of the construction project (e.g., a first subcontractor for concrete work, a second subcontractor for carpentry work, a third subcontractor for electrical work, etc.), where each such subcontract defines the scope of work to be performed by a subcontractor pursuant to the subcontract and the fees that the GC will pay to the subcontractor in connection with that work. Thus, the prime contract and the various subcontracts collectively define the work that must be done in order to complete the construction project, the agreed-upon costs (e.g., one or more Schedule of Values) for the work, and a schedule that lays out a timeline for the work to be completed.

However, during the course of a construction project, unexpected events may arise that may require a change to the previously-defined scope of the construction project, such as additional labor, equipment, and/or materials. For instance, a project owner may request a design change (e.g., a request to paint the building in a different color), a design flaw may be discovered, or an incident may occur that causes damage to a construction building and/or materials. Such unexpected events may require changes to the previously-defined scope of the construction project, including the overall work that needs to be performed, the expected costs for the construction project, and/or the schedule for completing the construction project. If such a change is ultimately made to the previously-defined scope of a construction project, that change is typically referred to as a “change order.”

Implementing a change order associated with an unexpected event can be inefficient and cumbersome, as it may require coordination between multiple parties (e.g., the project owner, the GC, and/or one or more subcontractors) to estimate, review, and/or approve additional work and/or costs associated with implementing the change order, formally documenting the additional work and/or costs associated with implementing the change order, and ensuring the change order is implemented, which is time-consuming and can introduce delays and inefficiencies.

### Overview

In an effort to alleviate some of the challenges associated with managing a construction project, including managing unexpected events that give rise to the need to generate change orders, software technology has been developed to enable users to coordinate with one another regarding unexpected events that impact the scope of a construction project. For instance, Procore Technologies, Inc. (“Procore”), who is the assignee of the present application, offers a construction management software application that includes various software tools that facilitate management of different aspects of a construction project, including software tools that help facilitate the process of creating and approving a change order on a construction project. For example, such software tools may enable users to document an unexpected event that is observed, enter related information about the unexpected event, and then if appropriate, submit a change order to formally revise a contract (e.g., a prime contract or a subcontract) in order to update the scope of work and expected costs of the construction project due to the unexpected event. In Procore's software application, unexpected events that may necessitate a change to the scope of the construction project and should be documented are referred to as “change events,” which serve as precursors for change orders that are ultimately generated for the construction.

For instance, when a user of Procore's software application becomes aware of a change event, the user may launch a “Change Events” software tool, either by accessing the “Change Events” tool directly from a “Tools” menu of Procore's software application or by selecting a “Create Change Event” option while accessing some other tool of Procore's software application where the user has documented an item from which the change event will originate. Such other tools may include, as some non-limiting examples, a Request for Information (“RFI”) tool where a user may enter RFI data items for the construction project to request and/or provide information about given project tasks, an “Inspections” tool where a user may enter inspections data items for the construction project that capture requirements associated with different types of inspections for the construction project (e.g., safety inspection), an “Observations” tool where a user may enter observation data items for the construction project that memorialize observations made during on-site inspections of the construction project, a “Punch Lists” tool where a user may enter punch lists data items for the construction project that memorialize punch items on the construction project, an “Emails” tool where a user may perform basic email functions (e.g., send, reply, forward, etc.) to communicate with one or more parties involved in the construction project, a “Meetings” tool where a user may enter meetings data items that enable the user to manage meetings (e.g., schedule meetings, select attendees, attach reference materials, create meeting agendas, create meeting minutes, etc.), a “Correspondence” tool where a user may enter correspondence data items that enable correspondence with one or more parties regarding certain aspects of the construction project (e.g., status updates, notices of delay, extensions of time, etc.), or an “Instructions” tool where a user may enter instruction data items that memorialize various types of instructions (e.g., architect instructions, site instructions, etc.) for the construction project. The “Change Events” software tool may be launched from within various other tools as well.

Upon accessing the “Change Events” software tool, the user may be presented with an interface for creating a new change event. Using this interface, the user is generally required to input (i) certain general information about the change event being created, such as a title, a description, a type of change, a reason for the change, and an indication, based on an operative contract for the construction project, of whether the change event is considered to be within or outside the scope of the construction project, as well as (ii) one or more change event “line items” that each specify an additional work activity that should potentially be performed on the construction project. In this respect, each such line item is generally comprised of various types of information, examples of which may include (a) a “budget code” (or the like) that classifies the scope of work that would need to be performed in view of the unexpected event and may include an indicator such as a “cost code” that identifies a type of additional work activity that is the subject of the line item (e.g., concrete work, carpentry work, electrical work, etc.) and/or an indicator such as a “cost type” that identifies a type of cost (e.g., labor, equipment, material, commitment, etc.) that would be incurred when performing the additional work activity, (b) a description of the additional work activity, (c) an indication of a company (e.g., a supplier, a vendor, etc.) that would perform the additional work activity, (d) an indication of a contract (e.g., a given prime contract, a given subcontract, etc.) with which the line item is associated, (e) an estimate of the cost that would be required to complete the additional work activity (which is sometimes referred to as a rough order of magnitude or “ROM” for short), and (f) perhaps also an estimate of the revenue that would be made by the company in connection with the additional work activity (which is sometimes referred to as the revenue ROM), among other possible types of information.

After a change event has been created, that change event may then be reviewed by an individual responsible for generating change orders for a construction project, and if appropriate, may ultimately be selected (via either the “Change Events” tool or some other tool of Procore's software application) for inclusion in a new change order that changes the previously-defined scope of the construction project—in which case the scope of work and expected costs entered as part of the change event would become part of the defined scope of the construction project.

While this existing software technology for documenting change events that may form the basis for change orders provides many benefits to individuals that are involved in managing changes to the scope of a construction project, it still presents some drawbacks.

As one example, the existing software technology for documenting change events puts the onus for determining when a change event should be created entirely on the user, which can lead to problematic situations. For instance, this increases the risk of a change event failing to be documented in a timely manner, or at all, which may result in undue cost(s) because the change is never paid for (e.g., if no change event is created, then a corresponding change order will not be created and the responsible party will never be charged) or because of lost time.

As another example, at the time of creating a change event, the existing software technology for documenting change events fails to provide any guidance as to what information should be included in line item(s) for the change event or what other previously-entered data items for the construction project (e.g., RFI items, inspection items, observation items, etc.) may be related to the change event, which again places the burden entirely on the user to identify and input such information. This requires the user to expend more time figuring out the exact information that needs to be included in the change event, which may be time consuming and also lead to errors (particularly involving information like an estimated cost of a line item).

To help address these and other problems, disclosed herein is new software technology that improves upon existing software technology for documenting change events that may potentially give rise to a change order. As described in further detail below, the disclosed software technology includes various aspects, which may be implemented either individually or in combination. For instance, the first or second software engines described above may run independently of each other and at different times, or may run in conjunction with one another, such as in instances where an output of one software engine forms part of an input for the other software engine.

According to a first aspect, the disclosed software technology comprises a first software engine that functions to (i) apply predictive analytics to other types of data items that have been created for a construction project in order to predict if any of those other types of data items warrants the creation of a new change event, and then (ii) if so, facilitate creation of the new change event. For instance, after a data item falling within a certain category of data items (e.g., an RFI data item, observation data item, meeting data item, email data item, etc.) is created for a construction project, the first software engine may function to (i) apply predictive analytics to the data for the data item (e.g., the information inputted by the user to create an RFI data item) in order to predict whether that data item suggests a need to create a new change event for the construction project, and (ii) if it is predicted that a new change event should be created, present a user with a recommendation to create a new change event along with a selectable option for the user to launch an interface for creating the new change event.

At its core, the first software engine may comprise program code that functions to apply predictive analytics to data for one or more data items created for a construction project in order to predict whether a new change event should be created based on the one or more data items. Additionally, the first software engine may optionally include program code that functions to pre-process the data for the one or more other data items before such data is input into the classification model using techniques such as Natural Language Processing (NLP) or the like. Additionally yet, the first software engine may include program code that runs when the classification model predicts that a new change event for the construction project should be created and functions to determine certain information for potential inclusion in the new change event based on the data for the one or more other data items, such as a predicted type of the new change event, a recommended title of the new change event, and/or a recommended description of the new change event, among other possibilities. The first software engine may take various other forms as well.

Further, the predictive analytics that are utilized by the first software engine to predict whether a new change event should be created based on one or more other data items may take any of various forms. For instance, as one possible implementation, the first software engine may utilize a classification model that is trained using a machine learning process (e.g., clustering) and functions to (i) receive, as input, data for one or more other data items that have been created for a construction project (e.g., one or more recently-created data items), (ii) evaluate the received data for the one or more other data items, and (iii) based on the evaluation, output a prediction of whether or not a new change event for the construction project should be created. The first software engine may utilize other types of predictive analytics as well.

Further yet, the first software engine may be run at various times. For instance, as one possibility, the first software engine may be run each time a new data item of a certain type (e.g., an RFI data item, observation data item, meeting data item, email data item, etc.) is created for the construction project. As another possibility, the first software engine may be run according to a schedule (e.g., once per minute). As yet another possibility, the first software engine may be run each time a certain type of user input is detected, such as each time a user requests access to a particular software tool of a construction management software application (e.g., a software tool for creating and managing change events). Still, as another possibility, the timing of the first software engine may depend on user information (e.g., for a given type of user, the first software engine may be run each time a new data item is created). The first software engine may be run at other times as well.

Still further, the output of the first software engine may take various forms. In general, the output of the first software engine may take the form of data that predicts either (i) that a new change event should be created or (ii) that a new change event should not be created. Further, the output may include data indicating a confidence level or some other strength metric associated with the prediction. The output may take other forms as well.

Based on the prediction that is output by the first software engine, a computing platform running the first software engine may perform certain actions. As one possibility, if the first software engine predicts that a new change event should be created, the computing platform may cause a user's client station to display a recommendation to create a new change event based on the new data item, which may be presented to the user (e.g., in the form of a notification or the like) along with a selectable option for the user to launch an interface for creating the new change event. In this respect, the recommendation to create the new change event could also include some information about the new change event being recommended, examples of which may include an indication of the one or more data items that led to the prediction of the new change event, an indication of a predicted type of the new change event, a recommended title of the new change event, and/or a recommended description of the new change event, among other possibilities. The output of the first software engine may take other forms as well—including but not limited to the possibility that the output is simply a generic recommendation to create a new change event without any other information about the new change event.

The first software engine provides several advantages over the existing software for creating change events. One such advantage is that the first software engine alleviates the burden that is currently placed exclusively on users to decide when a new change event should be created by (i) intelligently determining that a new change event should be created, (ii) recommending to the user that the new change event should be created, and (iii) optionally directing the user to an interface for creating the new change event. Other advantages also exist. The first software engine will be described in further detail below.

According to a second aspect, the disclosed software technology comprises a second software engine that functions to (i) apply predictive analytics to a set of initial information for a new change event that is in the process of being created for a construction project in order to identify additional information for potential inclusion in the new change event and then (ii) facilitate creation of the new change event. For instance, after receiving a set of initial information for a new change event that is in the process of being created for a construction project, the second software engine may function to (i) apply predictive analytics to the set of initial information for the new change event in order to predict what additional information should potentially be included in the new change event, and then (ii) present a user with a recommendation of what additional information to potentially include in the new change event along with functionality that enables the user to select which additional information to add to the new change event being created.

In this respect, the additional information that is identified by the second software engine could take any of various forms, examples of which may include identifiers of one or more other, previously-created data items for the construction project that are potentially related to the new change event (which may be referred to herein as “related items” for the new change event), additional scopes of work that appear to be implicated by the new change event, and an indication of how much the construction project's schedule is likely to be impacted by the new change event, among various other possibilities.

Further, the set of initial information that is evaluated by the second software engine may take any of various forms. As one possibility, the set of initial information may include certain initial information that is input by a user via an interface for creating a new change event, examples of which may include textual information about the new change event being created (e.g., a title and/or a description), audiovisual information related to the new change event being created (e.g., an image, a video, and/or an audio clip), an updated drawing for the construction project that is related to the new change event being created, and/or an updated building information modeling (BIM) model for the construction project that is related to the new change event being created, among other examples.

As another possibility, if the new change event is being created based on a recommendation output by the first software engine described above, the set of initial information may include certain information for the new change event that was determined by the first software engine (e.g., information that was extracted and/or derived from the received data during the course of evaluating the received data and predicting whether a new change event should be created), such as a predicted type of the new change event, a recommended title of the new change event, and/or a recommended description of the change event, among other examples.

As yet another possibility, if the new change event is being created in response to a user's request to create the new change event based on another data item that was previously created for the construction project, the set of initial information may include certain information for the new change event that is automatically determined by the first software engine based on the data included in that other data item. For example, if a user decides to create a new change event based on an RFI data item that was previously created using an RFI software tool (e.g., by selecting a “Create Change Event” option within the “RFI” software tool), the set of initial information for the new change event may include certain information that is automatically determined based on the data included in that RFI data item.

The set of initial information that is evaluated by the second software engine may take other forms as well.

At its core, the second software engine may comprise program code that functions to apply predictive analytics to an initial set of information for a new change event in order to identify additional information for potential inclusion in the new change event. In this respect, in practice, the second software engine may comprise a respective set of program code for each different class of additional information that is to be identified by the second software engine. For example, the second software engine could comprise a first set of program code that functions to apply predictive analytics for predicting related items for the new change event, a second set of program code that functions to apply predictive analytics for predicting additional scopes of work that appear to be implicated by the new change event, and/or a third set of program code that functions to apply predictive analytics for predicting how much the construction project's schedule is likely to be impacted by the new change event, among various other possibilities. Additionally, the second software engine may optionally include program code that functions to pre-process the set of initial information (using techniques such as NLP or the like) for a new change event before the predictive analytics are applied to the set of initial information. The second software engine may take various other forms as well.

Further, the predictive analytics utilized by the second software engine to identify the additional information may take any of various forms, which may depend on the class of additional information to be identified by the second software engine.

For instance, as one possibility, the additional information to be identified by the second software engine for potential inclusion in the new change event may include identifiers of other, previously-created data items for the construction project that are potentially related to the new change event, which as noted above may be referred to herein as “related items” of the new change event. Examples of such related items may include RFIs, drawings, documents, emails, observations, previous change events and/or change orders, conversations, tasks, and/or productivity logs, among other possible examples. In this respect, the predictive analytics that are utilized by the second software engine to identify related items for potential inclusion in the new change event may take the form of a predictive model that leverages a construction knowledge graph that includes information about the relationships between the various data items that have been created for the construction project. Such a knowledge graph may include, for instance, data representing a given data item's respective relationship with each of one or more other data items. For example, in an instance where a new change event is being created based on a given RFI, the construction knowledge graph may indicate (i) that the given RFI, which refers to an object that is a door, is related to the door and consequently the door's physical location, (ii) that the door is related to a given cost estimate that includes the door as a line item, and (iii) that the cost estimate may thus also be associated with the door's physical location. As a result, the predictive model may determine, based on the construction knowledge graph, that the given RFI is related to the given cost estimate and may thus identify the given cost estimate as a related item for the new change event. Other examples of how the predictive model may leverage information provided by the construction knowledge graph for the construction project are also possible. More information about knowledge graphs and their use in identifying related items can be found in U.S. patent application Ser. No. 17,307,869, filed May 4, 2021, and titled “Construction Knowledge Graph,” which is expressly incorporated by reference herein in its entirety.

After identifying related items for potential inclusion in the new change event, the second software engine may then cause the related items to be presented to the user in a manner that enables the user to select one or more related items to identify within and/or otherwise associate with the new change event being created, which may provide several advantages. One such advantage is that the identified related items(s) may provide additional context for the change event and enable easy access to the related item(s) when the change event is viewed later (e.g., when a user is evaluating whether to include the change event in a new change order for the construction project), which may improve the user experience of individuals tasked with creating change orders. Another such advantage is that associating the change event with other related items may improve the accuracy of the predictive analytics that are applied to identify any additional scopes of work, as discussed below. Other advantages may exist as well.

As another possibility, the additional information to be identified by the second software engine for potential inclusion in the new change event may include any additional scopes of work that appear to be implicated by the new change event, each of may be defined in terms of a categorization of the additional scope of work (e.g., a budget code or the like), an indication of at least one company (e.g., a contractor, supplier, vendor, etc.) that would be tasked with performing the additional scope of work (perhaps along with an indication of the operative contract for the company), and an estimate of the cost that would be required to complete the additional scope of work, among other possible types of information. In this respect, the predictive analytics that are utilized by the second software engine to predict which scopes of work should be included in the new change event may take any of various forms.

For instance, as one possible implementation, the second software engine may predict which scopes of work should be included in the new change event using a combination of a classification model for predicting the categories of additional work activities that are most likely implicated by the new change event, data indicating a category-by-category breakdown of which companies handle work activities on the construction project, and one or more models for estimating the cost of the additional work activities in the predicted categories.

In such an implementation, the classification model used to predict the categories of additional work activities that are most likely implicated by the new change event may be trained using a machine learning process (e.g., clustering to determine classes) and may function to (i) receive, as input, the set of initial information for the new change event (and perhaps also the related items identified as described above), (ii) evaluate the set of initial information for the new change event (and perhaps also the related items identified as described above), and (iii) based on the evaluation, predict which one or more categories of additional work activities are most likely to be implicated by the new change event. After the classification model predicts the one or more categories of additional work activities, then for each predicted category of additional work activity, the second software engine may (i) use data indicating a category-by-category breakdown of which companies handle work activities on the construction project to determine which one or more companies are most likely to perform the additional work activity in the predicted category and (ii) use one or more models to estimate a cost of the additional work activity in the predicted category. Each predicted category of additional work activity, along with the corresponding company and estimated cost that is predicted for that category, may then be identified as one scope of work that should potentially be included in the new change event. Additionally, in some implementations, the second software engine may also use data representing the operative contract related to each identified scope of work in order to predict any expected costs related to the identified scope of work and whether those costs would be considered within the scope of the operative contract or outside the scope of the operative contract (which dictates who would be responsible for paying for the scope of work if the change event were elevated to a change order).

After identifying the additional scopes of work for potential inclusion in the new change event, the second software engine may then cause the additional scopes of work to be presented to the user in a manner that enables the user to select which of the identified scopes of work are to be added as line items for the new change event being created, which may provide several advantages. One such advantage is that the identified scopes of work alleviate the burden on the user creating the new change event to actively identify any potential other work that may be impacted by the new change event and may thus reduce the chances of potentially impacted work being inadvertently overlooked. Another such advantage is that associating the change event with any identified scopes of work may improve the accuracy of the predictive analytics that are applied to identify any scheduling impacts, as discussed below. Other advantages may exist as well.

As yet another possibility, the additional information to be identified by the second software engine for potential inclusion in the new change event may include an indication of how much the construction project's schedule is likely to be impacted by the new change event. For instance, as one possible implementation, the second software engine may function to (i) evaluate whether any of the identified scopes of work impact activities along a “critical path” of the construction project, and then (ii) if so, apply predictive analytics to estimate an amount of time by which the construction project is likely to be delayed as a result of the identified scopes of work. In this respect, the predictive analytics utilized by the second software engine to identify such determined impacts to the critical path could take the form of a predictive model that is trained using a machine learning process and functions to (i) receive, as input, the identified scopes of work and the current schedule for the construction project, (ii) evaluate each identified scope of work vis-à-vis the critical path of the construction project, and (iii) based on the evaluation, predict an amount of delay that each identified scope of work is likely to introduce into the critical path (which could be a zero delay for identified scopes of work that do not impact the critical path and a non-zero delay for identified scopes of work that do impact the critical path).

Information regarding any identified scheduling impacts, such as critical activities and consequent timing delays and/or cost impacts, may then be presented to the user, which may provide several advantages. One such advantage may be that the identified scheduling impacts may provide additional context that may aid the user in deciding which identified scopes of work to add as line items for the change event and thereby include as part of the data defining the change event.

After the user has selected any identified additional information that the user wishes to include in the change event as mentioned above (e.g., by selecting identifiers for one or more related items and/or one or more affected scopes of work), the user may then select an option to save and/or create the change event. After the change event has been created, it may be selected for inclusion in (or otherwise associated with) a future change order.

The second software engine will be described in further detail below.

Accordingly, in one aspect, disclosed herein is a method that involves a computing system (i) receiving, from a client station associated with a user, a request to create a new change event for a construction project; (ii) obtaining a set of initial information about the new change event; (iii) evaluating the set of initial information about the new change event using predictive analytics and thereby predicting one or more scopes of work that are likely implicated by the new change event, wherein each of the one or more scopes of work comprises a category of work activity and an estimated cost of performing the work activity; (iv) causing the client station to present the one or more scopes of work that are likely implicated by the new change event; (v) receiving, from the client station, data indicating that the user has selected at least one given scope of work from the one or more scopes of work; and (vi) creating a data item that represents the new change event and includes data defining the at least one given scope of work selected by the user.

In another aspect, disclosed herein is a computing system that includes a network interface, at least one processor, a non-transitory computer-readable medium, and program instructions stored on the non-transitory computer-readable medium that are executable by the at least one processor to cause the computing system to carry out the functions disclosed herein, including but not limited to the functions of the foregoing method.

In yet another aspect, disclosed herein is a non-transitory computer-readable storage medium having program instructions stored thereon that are executable to cause a computing system to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions according to the disclosed software technology.

FIG. 3 depicts an example of a first software engine that is configured to predict whether other types of data items warrant creation of a new change event for a construction project.

FIG. 4A depicts an example process for training a classification model that may be utilized by the first software engine.

FIG. 4B depicts an example machine learning process that may be used to train the classification model of FIG. 4A.

FIG. 5 depicts an example process for predicting that a new change event should be created utilizing the first software engine.

FIGS. 6A-6B depict example GUI views that may be presented to a user in accordance with a first aspect of the disclosed technology.

FIG. 7 depicts an example of a second software engine that is configured to identify additional information for potential inclusion in a new change event that is in the process of being created for a construction project.

FIG. 8 depicts an example process for creating one or more models that may be utilized by the second software engine to identify additional information for potential inclusion in a new change event that is in the process of being created for a construction project.

FIG. 9 depicts an example process for identifying additional information for potential inclusion in a new change event utilizing the second software engine.

FIG. 10A-10B depict example GUI views that may be presented to a user in accordance with a second aspect of the disclosed technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example System Configuration

The present disclosure is generally directed to software technology for generating predictive change events. At a high level, the disclosed software technology may function to (i) apply predictive analytics to data for one or more data items created for a construction project in order to predict whether a new change event should be created based on the one or more data items and/or (ii) apply predictive analytics to an initial set of information for a new change event in order to identify additional information for potential inclusion in the new change event, among various other functions that are performed by the disclosed software technology and are described in further detail below. This disclosed software technology may be incorporated into one or more software applications that may take any of various forms.

As one possible implementation, this software technology may be incorporated into a software as a service (“SaaS”) application that includes both front-end software running on one or more client stations that are accessible to individuals associated with construction projects (e.g., contractors, subcontractors, project managers, architects, engineers, designers, etc., each of which may be referred to generally herein as a “construction professional”) and back-end software running on a back-end computing platform (sometimes referred to as a “cloud” platform) that interacts with and/or drives the front-end software, and which may be operated (either directly or indirectly) by the provider of the front-end client software. As another possible implementation, this software technology may be incorporated into a software application that takes the form of front-end client software running on one or more client stations without interaction with a back-end computing platform. The software technology disclosed herein may be incorporated into software applications that take other forms as well. Further, such front-end client software may take various forms, examples of which may include a native application (e.g., a mobile application), a web application running on a client station, and/or a hybrid application, among other possibilities.

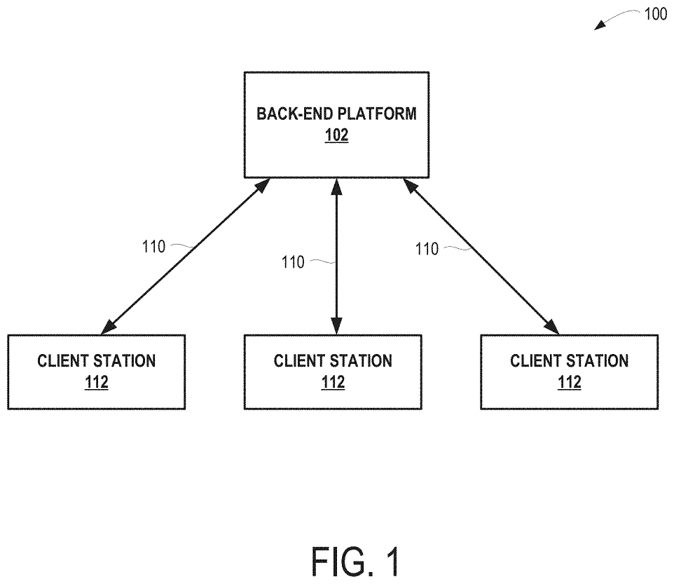

Turning now to the figures, FIG. 1 depicts an example network configuration 100 in which example embodiments of the present disclosure may be implemented. As shown in FIG. 1, network configuration 100 includes a back-end computing platform 102 that may be communicatively coupled to one or more client stations, depicted here, for the sake of discussion, as client stations 112.

Broadly speaking, back-end computing platform 102 may comprise one or more computing systems that have been provisioned with software for carrying out one or more of the functions disclosed herein, including but not limited to functions related to receiving and evaluating data and outputting data and/or instructions that define the visual appearance of a front-end interface (e.g., a graphical user interface (GUI)) through which the data is presented on the one or more client stations. The one or more computing systems of back-end computing platform 102 may take various forms and be arranged in various manners.

For instance, as one possibility, back-end computing platform 102 may comprise computing infrastructure of a public, private, and/or hybrid cloud (e.g., computing and/or storage clusters) that has been provisioned with software for carrying out one or more of the functions disclosed herein. In this respect, the entity that owns and operates back-end computing platform 102 may either supply its own cloud infrastructure or may obtain the cloud infrastructure from a third-party provider of “on demand” computing resources, such as Amazon Web Services (AWS) or the like. As another possibility, back-end computing platform 102 may comprise one or more dedicated servers that have been provisioned with software for carrying out one or more of the functions disclosed herein. Other implementations of back-end computing platform 102 are possible as well.

In turn, client stations 112 may each be any computing device that is capable of running the front-end software disclosed herein. In this respect, client stations 112 may each include hardware components such as a processor, data storage, a communication interface, and user-interface components (or interfaces for connecting thereto), among other possible hardware components, as well as software components that facilitate the client station's ability to run the front-end software incorporating the features disclosed herein (e.g., operating system software, web browser software, mobile applications, etc.). As representative examples, client stations 112 may each take the form of a desktop computer, a laptop, a netbook, a tablet, a smartphone, and/or a personal digital assistant (PDA), among other possibilities.

As further depicted in FIG. 1, back-end computing platform 102 may be configured to interact with client stations 112 over respective communication paths 110. In this respect, each communication path 110 between back-end computing platform 102 and one of client stations 112 may generally comprise one or more communication networks and/or communications links, which may take any of various forms. For instance, each respective communication path 110 with back-end computing platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 110 with back-end computing platform 102 may be wireless, wired, or some combination thereof, and may carry data according to any of various different communication protocols. Although not shown, the respective communication paths 110 between client stations 112 and back-end computing platform 102 may also include one or more intermediate systems. For example, it is possible that back-end computing platform 102 may communicate with a given client station 112 via one or more intermediary systems, such as a host server (not shown). Many other configurations are also possible.

While FIG. 1 shows an arrangement in which three particular client stations are communicatively coupled to back-end platform 102, it should be understood that this is merely for purposes of illustration and that any number of client stations may communicate with back-end platform 102.

Although not shown in FIG. 1, back-end computing platform 102 may also be configured to receive data, such as data related to a construction project, from one or more external data sources, such as an external database and/or another back-end computing platform or platforms. Such data sources—and the data output by such data sources—may take various forms.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. Example Computing Platform

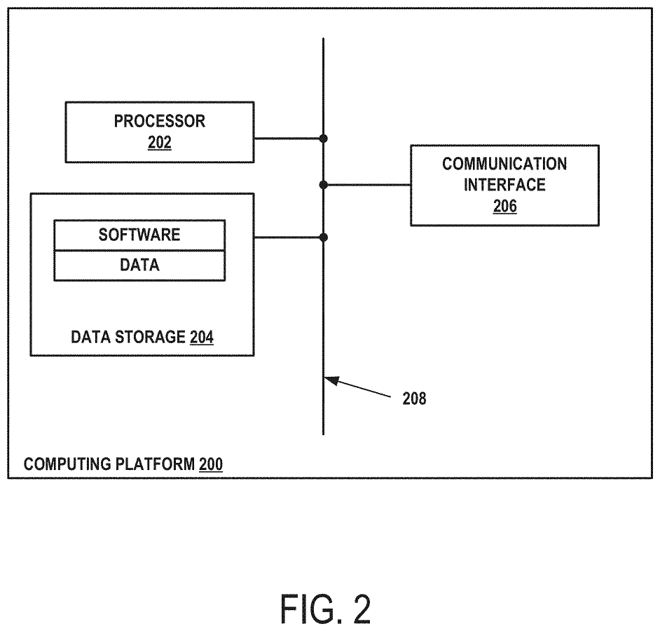

FIG. 2 is a simplified block diagram illustrating some structural components that may be included in an example computing platform 200, which could serve as, for instance, the back-end computing platform 102 of FIG. 1. In line with the discussion above, computing platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums that are collectively configured to store (i) program instructions that are executable by processor 202 such that computing platform 200 is configured to perform some or all of the disclosed functions, which may be arranged together into software applications, virtual machines, software development kits, toolsets, or the like, and (ii) data that may be received, derived, or otherwise stored, for example, in one or more databases, file systems, or the like, by computing platform 200 in connection with the disclosed functions. In this respect, the one or more non-transitory computer-readable storage mediums of data storage 204 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 204 may comprise computer-readable storage mediums that are distributed across a plurality of physical computing devices connected via a network, such as a storage cluster of a public, private, or hybrid cloud. Data storage 204 may take other forms and/or store data in other manners as well.

Communication interface 206 may be configured to facilitate wireless and/or wired communication with external data sources and/or client stations, such as one or more client stations 112 of FIG. 1. Additionally, in an implementation where computing platform 200 comprises a plurality of physical computing devices connected via a network, communication interface 206 may be configured to facilitate wireless and/or wired communication between these physical computing devices (e.g., between computing and storage clusters in a cloud network). As such, communication interface 206 may take any suitable form for carrying out these functions, examples of which may include an Ethernet interface, a Wi-Fi network, a cellular network, a serial bus interface (e.g., Firewire, USB 3.0, etc.), a chipset and antenna adapted to facilitate wireless communication, short-range wireless protocols, and/or any other interface that provides for wireless and/or wired communication. Communication interface 206 may also include multiple communication interfaces of different types. Other configurations are possible as well.

Although not shown, computing platform 200 may additionally include or have one or more interfaces for connecting to user-interface components that facilitate user interaction with computing platform 200, such as a keyboard, a mouse, a trackpad, a display screen, a touch-sensitive interface, a stylus, a virtual-reality headset, and/or speakers, among other possibilities, which may allow for direct user interaction with computing platform 200. Further, although not shown, a client station, such as one or more of the client stations 112, may include similar components to the computing platform 200, such as a processor, a data storage, and a communication interface. Further, the client station may also include or be connected to a device, such as a smartphone, a laptop, a tablet, or a desktop, among other possibilities, that includes integrated user interface equipment, such as a keyboard, a mouse, a trackpad, a display screen, a touch-sensitive interface, a stylus, a virtual-reality headset, speakers, etc., which may allow for direct user interaction with computing platform 200.

It should be understood that computing platform 200 is one example of a computing platform that may be used with the embodiments described herein. Numerous other arrangements are possible and contemplated herein. For instance, other computing platforms may include additional components not pictured and/or more or fewer of the pictured components.

### III. Example Operations

As mentioned above, disclosed herein is new software technology that improves upon existing software technology for documenting change events that may potentially give rise to a change order. The disclosed software technology comprises various aspects that may be implemented either individually or in combination, which will now be described in further detail. Further, in practice, the disclosed software technology may be incorporated into any software application that facilitates changes orders on a construction project, including but not limited to construction management software applications.

a. First Software Engine

According to a first aspect, the disclosed software technology comprises a first software engine that functions to (i) apply predictive analytics to data items that have been created for a construction project in order to predict if any of those data items warrants the creation of a new change event, and then (ii) if so, facilitate creation of the new change event. For instance, after a data item falling within a certain category (e.g., an RFI data item, observation data item, meeting data item, email data item, etc.) is created for a construction project, the first software engine may function to (i) apply predictive analytics to the data defining the data item (e.g., the information inputted by the user to create an RFI data item) in order to predict whether that data item suggests a need to create a new change event for the construction project, and (ii) if it is predicted that a new change event should be created, present a user with a recommendation to create a new change event along with a selectable option for the user to launch an interface for creating the new change event.

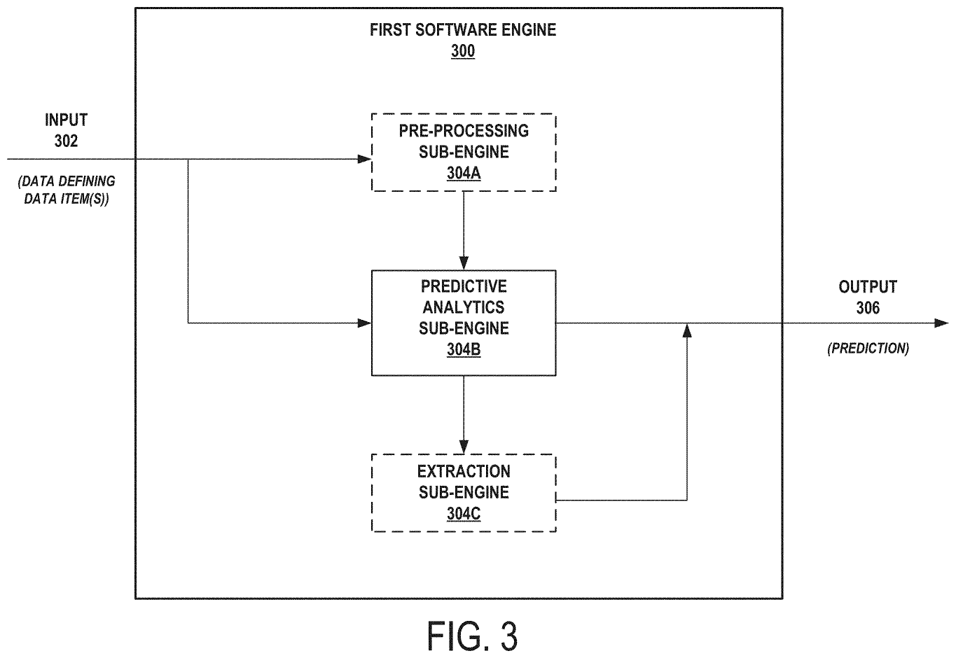

FIG. 3 illustrates one possible example configuration of the first software engine that functions to (i) receive, as input, data defining one or more data items that have been created for a construction project, (ii) evaluate the received data defining the one or more data items, and (iii) based on the evaluation, predict whether or not a new change event for the construction project should be created. The example first software engine 300 may be configured to receive, as input 302, data defining one or more data items for a construction project. In this respect, the one or more data items that are input into the classification model may take various forms. As one possibility, such one or more data items may take the form of a single data item for a construction project that was recently created by a user, which may be, for example, the most recently-created data item for the construction project. As another possibility, such one or more data items may take the form of a set of multiple data items for a construction project that were recently created by a same user. As yet another possibility, such one or more data items may take the form of a most recently-created data item along with one or more other previously-created data items that are determined to be related to the recently-created data item (e.g., through the use of a knowledge graph or the like), among other possibilities. The one or more data items may take other forms as well.

The input 302 may then be provided to the sub-engine 304A, which comprises program code that functions to pre-process the input 302, which may take various forms. As one example, pre-processing may take the form of Natural Language Processing (“NLP”) techniques that analyze user-inputted data in a way that enables a computing platform running the first software engine to better “understand” the overall context of the data. Such NLP techniques may include, as some nonlimiting examples, identifying and extracting keywords and/or key features from the raw text included in user-inputted data, correcting any spelling and/or grammatical errors, unification, non-ascii character removal, stop word removal, lemmatization, and sentiment analysis.

After pre-processing is complete, the input 302 may be passed to the sub-engine 304B, which comprises program code that functions to apply predictive analytics to the input 302 in order to predict whether a new change event should be created based on the one or more data items. Alternatively, the input 302 may be provided directly to the predictive analytics sub-engine 304B without applying any pre-processing. As yet another alternative, certain parts of the input 302 may be provided directly to the predictive analytics sub-engine 304B, and certain other parts of the input 302 may be provided first to the pre-processing sub-engine 304A, after which the certain other parts may be passed on to the predictive analytics sub-engine 304B.

Thereafter, the predictive analytics sub-engine 304B may evaluate the input 302 and yield an output 306, which may take various forms. In general, the output of the first software engine may comprise data indicating either (i) a prediction that a new change event should be created or (ii) a prediction that a new change event should not be created. Further, the output may include data indicating a confidence level or some other strength metric associated with the prediction. The output may take other forms as well.

Additionally, or alternatively, in some implementations where the first software engine outputs a prediction that a new change event should be created, the extraction sub-engine 304C may be run. The extraction sub-engine 304C includes program code that is configured to run when the predictive analytics sub-engine 304B predicts that a new change event for the construction project should be created and functions to determine (e.g., extract, import a copy of, and/or otherwise derive) certain data for potential inclusion in the new change event based on the data defining the one or more other data items. Such determined data may include information such as a predicted type of the new change event, a recommended title of the new change event, and/or a recommended description of the new change event, among other possibilities. The extraction sub-engine 304C may then include in the output 306 that determined data, along with the prediction that the change event should be created. The first software engine may take various other forms as well.

In practice, the first software engine 300 may be created by a back-end computing platform, which may be, for example, the computing platform 200 described above. The process of creating the first software engine that applies predictive analytics to predict whether a new change event should be created based on one or more other data items may take any of various forms.

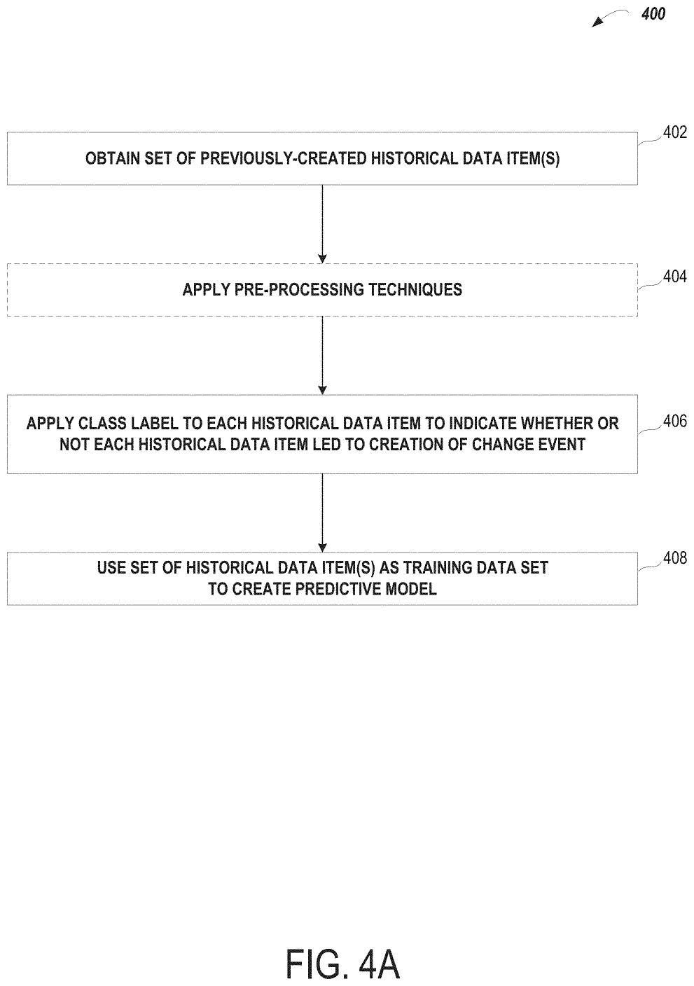

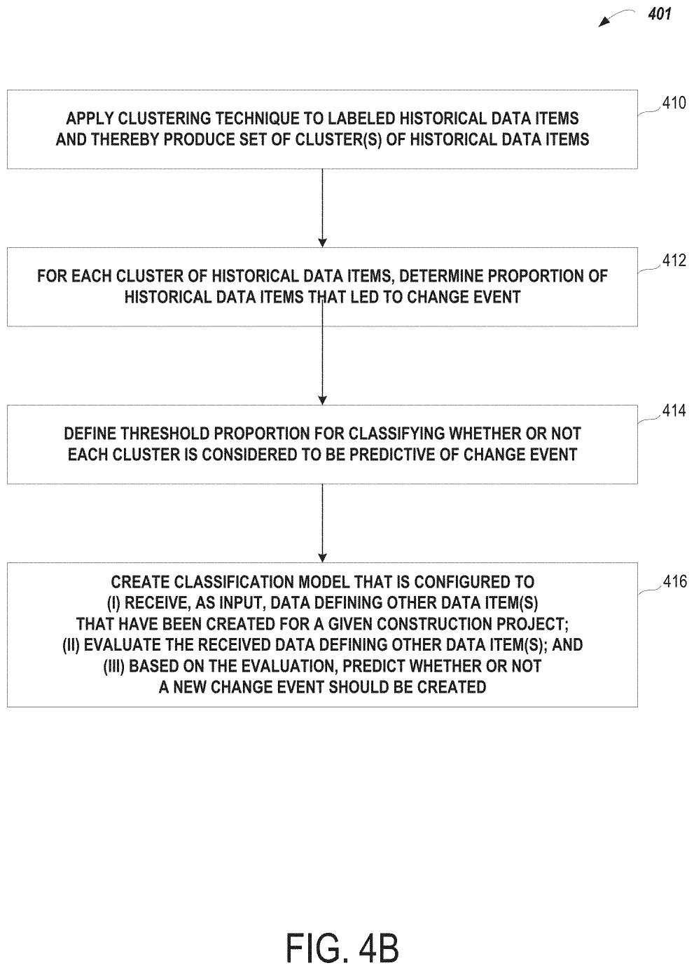

As one possibility, the predictive analytics may comprise a classification model that is trained using a machine learning process (e.g., clustering). FIG. 4A illustrates one possible example of a process 400 for creating a training data set for such a classification model.

The example process 400 may begin at block 402, where the back-end computing platform may obtain a set of one or more historical data items that have been previously created for one or more construction projects using a construction management software application. Such historical data items may take various forms, including any of the data items previously discussed herein, such as RFI data items, observation data items, punch list data items, or correspondence data items, among other possibilities. Each historical data item may include respective data defining the historical data item, which may take the form of values corresponding to various different data variables. Such data variables may include, for example, a data item type (e.g., RFI, Observations, Correspondence, etc.), a data item title that uniquely identifies the data item, a data item description that generally describes the data item, and other information that may be specific to the type of data item. For instance, an RFI data item may include information about an “Assignee” that is responsible for providing requested information, an observation data item may include information about a “Status” or “Location” of the observation, a correspondence data item may include information about “Distribution” indicating to whom the correspondence data item was distributed, and so forth. In some implementations, each historical data item may additionally include information about other data items that are “linked” or otherwise related to the historical data item. For instance, certain types of data items may be linked with one or more other data items such that the data defining the one or more other data items may be easily referenced or accessible when viewing the data item. For example, a correspondence data item can be linked with one or more other data items, such as an Extension of Time or a Notice of Delay. Further, certain types of data items may include related items, such as additional information pertaining to the data item (e.g., an RFI data item may include a related item such as an additional Location, etc.) or one or more relevant attachments. Still further, information about one or more related data items for each historical data item may be determined using a knowledge graph (or the like) that tracks the relationships between the various data items that have been created for the construction project.

At block 404, the back-end computing platform may optionally pre-process the data defining the set of previously-created historical data items so as to increase the suitability of the data and/or determine one or more features of the data for use as training data for the classification model. Such pre-processing may take various forms, including those utilized by the pre-processing sub-engine 304A of FIG. 3. As one example, such pre-processing may take the form of any of the NLP techniques described above.

At block 406, after obtaining the set of one or more previously-created historical data items and optionally pre-processing the data defining the set of historical data items, the back-end computing platform may perform a classification labeling operation whereby each historical data item is assigned a class label (e.g., a string value such as “Yes” or “No” that is mapped to a respective numeric value such as “1” or “0”) that indicates whether or not the historical data item led to the creation of a change event. The labeling operation may determine if the historical data item led to the creation of a change event in various ways. As one possibility, the labeling operation may determine if each historical data item directly led to the creation of a change event. For instance, if a given historical data item is linked to a change event data item, the labeling operation may determine that the given historical data item directly led to the creation of a change event.

As another possibility, the labeling operation may determine if each historical data item indirectly led to the creation of a change event. For instance, if the data defining a given historical data item indicates any determined related data items, the labeling operation may evaluate the related data items collectively to determine whether or not each of those related data items led to the creation of a change event, in which case as long as any one data item in a collection of related data items is determined to have led to the creation of a change event, the labeling operation may determine that the given historical data item led, at least partially, to the creation of the change event, and may label the given historical data item with an indication that a change event was created based at least in part on the given historical data item and may further label each related data item in the collection of data items related to the given historical data item with an indication that a change event was created based at least in part on the related data item. Other ways of determining whether a given historical item led to the creation of a change event and labeling the given historical item with an indication that it led to the creation of a change event are also possible.

At block 408, after the back-end computing platform has completed the classification labeling operation, the set of one or more labeled historical data items may be used as a training dataset for a machine learning process that functions to train a classification model that is configured to (i) receive, as input, data for one or more other data items that have been created for a construction project, (ii) evaluate the received data for the one or more other data items, and (iii) based on the evaluation, predict whether or not a new change event for the construction project should be created based on the one or more other data items. The machine learning process may take various forms.

FIG. 4B illustrates one implementation of a machine learning process 401 that may be used to train the classification model. In such an implementation, the machine learning process may begin at block 410 by applying a clustering technique (or sometimes referred to as a cluster analysis) that clusters the labeled historical data items in the set of historical data items based on one or more features included or associated with the labeled historical data items and thereby produces a set of one or more “clusters” of historical data items, where the data items in each respective cluster have similar features to one another. For example, a first subset of the historical data items may have been clustered together in one cluster based on a similar characteristic comprising a similar data item type (e.g., an RFI). As another example, a second subset of the historical data items may have been clustered together in another cluster based on similar characteristics comprising certain similar keywords identified in each historical data item's description (e.g., “burst,” “damage,” “replace,” etc.). Historical data items may be clustered together based on other similar characteristics as well.

Next, at block 412, for each identified cluster of historical data items, the machine learning process may determine a respective proportion of historical data items in the cluster that actually led to a change event. For example, the machine learning process may determine that 51% of the historical data items in a first example cluster led to a change event, 80% of the historical data items in a second example cluster led to a change event, and so forth.

In turn, at block 414, the machine learning process may define a threshold proportion for use in classifying whether or not each cluster is considered to be predictive of a change event. For example, the machine learning process may define a threshold of some percentage value (e.g., 75% or 51%), where any cluster having a respective proportion of historical data items in the cluster that actually led to a change event that is equal to or greater than that threshold percentage value will be deemed a cluster that is predictive of a change event, whereas any cluster having a respective proportion of historical data items in the cluster that actually led to a change event that is less than that threshold percentage value will be deemed a cluster that is not predictive of a change event. In this respect, if the threshold percentage value is 75%, only the second example cluster discussed above would be determined to be predictive of a change event, whereas if the threshold percentage value is 51%, both the first and second example clusters discussed above would be determined to be predictive of a change event.

Next, at block 416, the identified set of one or more clusters, the respective proportion determined for each cluster, and the defined threshold proportion may all be embodied in the classification model that functions to (i) receive data for one or more data items, (ii) based on the received data, classify the one or more data items into a given cluster, and then (iii) predict whether or not a change event should be created for the one or more data items based on whether or not the determined proportion for the given cluster exceeds the threshold.

In another implementation, the machine learning process may begin by performing a cluster analysis on the labeled historical data items multiple times using different clustering techniques, which may cluster the set of historical data items in different ways and thereby produce multiple different sets of clusters of historical data items. Then, for each different set of clusters, the machine learning process may perform similar functions to those described above (e.g., determining a respective proportion of the respective historical data items in each identified cluster that led to the creation of a change event and then defining a threshold proportion for use in classifying whether each identified cluster is considered to be predictive of a change event) to create a different classification model from each different set of clusters, where the prediction of whether or not a change event should be created may differ from model to model.

Thereafter, the different classification models may be combined and embodied in a single ensemble classification model that functions to (i) determine each individual classification model's respective prediction of whether or not a change event should be created (based on each classification model's identified clusters, determined proportions, and thresholds) and then (ii) aggregate the respective predictions into a single, overall prediction of whether or not a change event should be created. The logic used by the ensemble classification model to aggregate the respective predictions into the overall prediction of whether or not a change event should be created may take various forms. As one possibility, the ensemble classification model may first determine what proportion of the individual predictions comprise a positive prediction that a change event should be created and then determine whether or not that proportion meets a given threshold (e.g., 50% or perhaps higher) as the means for rendering the overall prediction of whether or not a change event should be created. As another possibility, the ensemble classification model may perform a weighted evaluation of each individual classification model's respective prediction of whether or not a change event should be created such that the individual predictions of certain classification models influence the overall prediction more heavily than the individual predictions of other classification models. The ensemble classification model may render the overall prediction of whether or not a change event should be created in other manners as well.

In yet another implementation, the machine learning process may begin by identifying a given set of features that are most predictive of a change event (e.g., the 5 or 10 features that are most commonly associated with historical data items that resulted in a change event). In turn, the given set of features may be utilized to create a classification model that functions to (i) receive data for one or more data items, (ii) based on the received data, determine whether or not the one or more data items are associated with any one or more of the features in the given set (e.g., by applying pre-processing techniques to determine if certain keywords indicative of the feature(s) are present in the received data, etc.), and then (iii) predicting whether or not a change event should be created for the one or more data items based on whether or not the one or more data items are associated with any one or more of the features in the given set.

Other examples for training a classification model that is used to predict whether a new change event should be created based on one or more other data items are also possible.

The first software engine may utilize other types of predictive analytics in order to predict whether a new change event should be created based on one or more other data items as well. The first software engine may take various other forms as well.

Further, the first software engine may be run at various times. For instance, as one possibility, the first software engine may be run each time a new data item within any of certain categories of data items (e.g., an RFI data item, an observation data item, a correspondence data item, etc.) is created for the construction project. As another possibility, the first software engine may be run according to some predefined interval (e.g., once per minute, once every five minutes, etc.). As yet another possibility, the first software engine may be run each time a certain type of user input is detected, such as each time a user requests access to a particular software tool of a construction management software application (e.g., a software tool for creating and managing change events, a software tool for creating and managing RFIs, etc.). Still, as another possibility, the timing of the first software engine may depend on user information, such as user permissions (e.g., administrator-level permissions, etc.), user type (e.g., owner, GC, subcontractor, etc.), user affiliations (e.g., a type of contractor or a particular vendor with which the user is affiliated, such as a contractor responsible for electrical work, plumbing work, etc.), among other possibilities. For example, for a given type of user or for a user with a given permission level, the first software engine may be run each time the user creates a new data item. The first software engine may also be run based on a combination of one or more of the above timings. The first software engine may be run at other times as well.

As mentioned above, the output of the first software engine may take various forms. As one possibility, the output of the first software engine may comprise data that indicates either (i) a prediction that a new change event should be created or (ii) a prediction that the data item(s) do not warrant creation of a new change event. Additionally, or alternatively, the output may include data indicating a confidence level or some other strength metric associated with the prediction. The output may take other forms as well.

Based on the output of the first software engine, the back-end computing platform may perform certain actions. As one possibility, if the first software engine predicts that a new change event should be created, the back-end computing platform may output a recommendation to create a new change event based on the new data item, which may then be presented to a user. The recommendation that is presented to the user may take various forms. As one possibility, the recommendation may take the form of a notification, such as a pop-up notification or a window overlay, that is displayed to the user via a client station and indicates to the user that based on data defining one or more data items, creating a new change event is recommended. Further, the notification may include or be otherwise accompanied with a selectable option for the user to launch a software tool for creating the new change event. In this respect, the recommendation to create the new change event could also include some information about the new change event being recommended, examples of which may include an indication of the one or more data items that led to the prediction of the new change event, an indication of a predicted type of the new change event, a recommended title of the new change event, and/or a recommended description of the new change event, among other possibilities. The recommendation that is presented to the user may take other forms as well—including but not limited to the possibility that the recommendation is simply a generic recommendation to create a new change event without any other information about the new change event and without a selectable option to launch the software tool for creating the new change event.

As another possibility, in some implementations where the first software engine predicts that a new change event should be created, the back-end computing platform may automatically launch the software tool for creating the new change event, determine any data that should be included in the data defining the new change event as described above, and present the user with the data defining the new change event, whereby the user may revise the data defining the new change event and/or select an option to “save” the new change event in order to cause the platform to create a data item for the new change event. In such implementations, the determined data could also serve as input for the second software engine, which will be described in more detail further below.

Still, in some implementations, when the first software engine predicts that a new change event should be created, the back-end computing platform may automatically create the new change event, which may involve determining data that should be included in the data defining the new change event as described above and then creating a data item for the new change event that includes the determined data (perhaps along with other data derived by the back-end computing platform).

If the first software engine's recommendation to create a new change event leads to the creation of the new change event (either at the request of a user or automatically by the back-end computing platform), that new change event may then be available for future inclusion in a new change order that revises the scope of the construction project based at least in part on that change event.

As yet another possibility, if the first software engine predicts that creation of a change event is not warranted by the data item(s), the back-end computing platform may take no action involving presenting an indication of the output to the user. However, in such implementations, the back-end computing platform may optionally log and store the output for reference and may include information regarding the date and/or time when the predictive analytics were run, the output indicating that no change event was warranted by the data item(s), and information regarding the data item(s) that served as input for the first software engine. The back-end computing platform may take other actions based on the output of the first software engine as well.

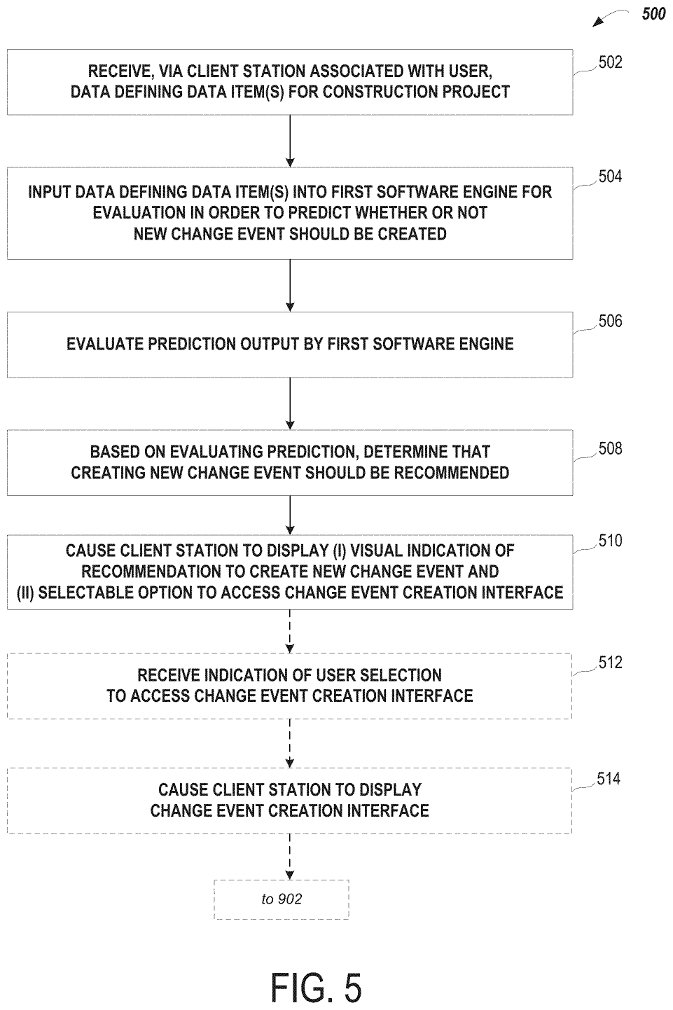

With reference now to FIG. 5, an example process 500 for predicting whether or not a new change event should be created according to the first aspect of the disclosed software technology is shown.

In practice, the example process 500 may begin at block 502, when a back-end computing platform that is running a software application incorporating the disclosed technology receives, via a graphical user interface (“GUI”) displayed at a client station associated with a user, user-inputted data defining a new data item for a given construction project. Such a data item may take various forms, including a data item within any of the categories of data items previously discussed (e.g., an RFI data item, an observations data item, a correspondence data item, etc.). While the example process 500 is described in the context of the back-end computing platform running the software engine after receiving one particular data item, it should be understood that the platform may run the software engine at various other times as well, including those described above, one example of which may be after receiving multiple different data items, which may be of the same type or of different types.

Optionally, in some implementations, receiving the data defining the new data item may involve identifying other previously-created data items that are related to the new data item, such as additional information pertaining to the data item (e.g., the new data item may be an RFI data item that includes a related data item such as an additional Location, etc.) or any relevant attachments, as previously described.

The GUI view that may be displayed to a user for inputting data defining a new data item may take various forms and may include various sections and corresponding fields that enable the user to input data about the new data item, which may include, as some examples, a numerical identifier, a subject, a description, a manager, and an assignee of the data item. The types of fields that are included in the GUI view may be based on the type of data item that is being created.

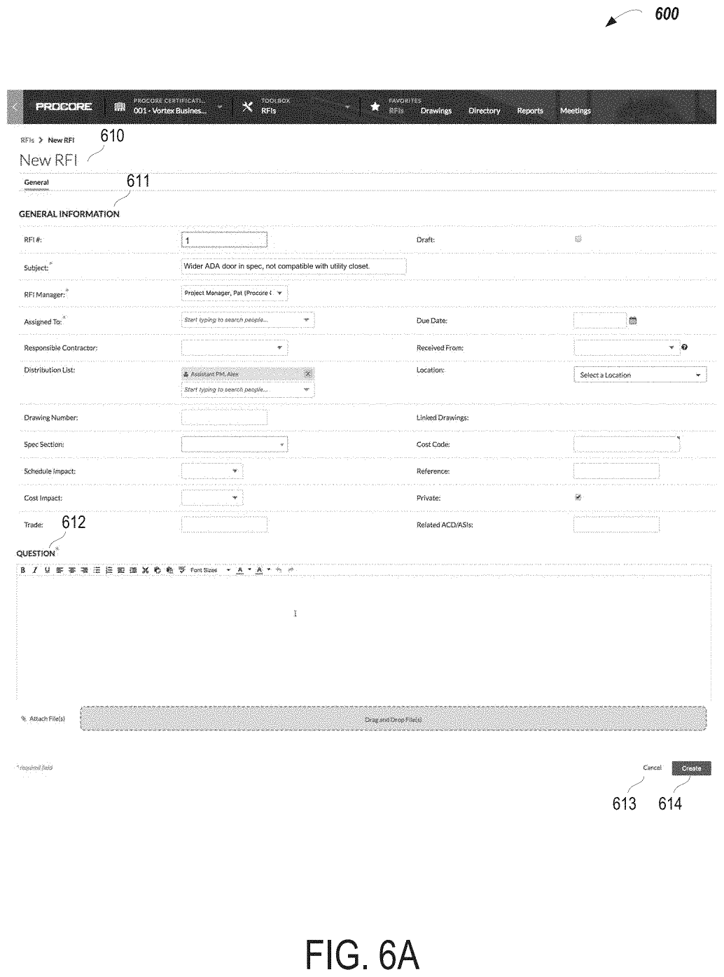

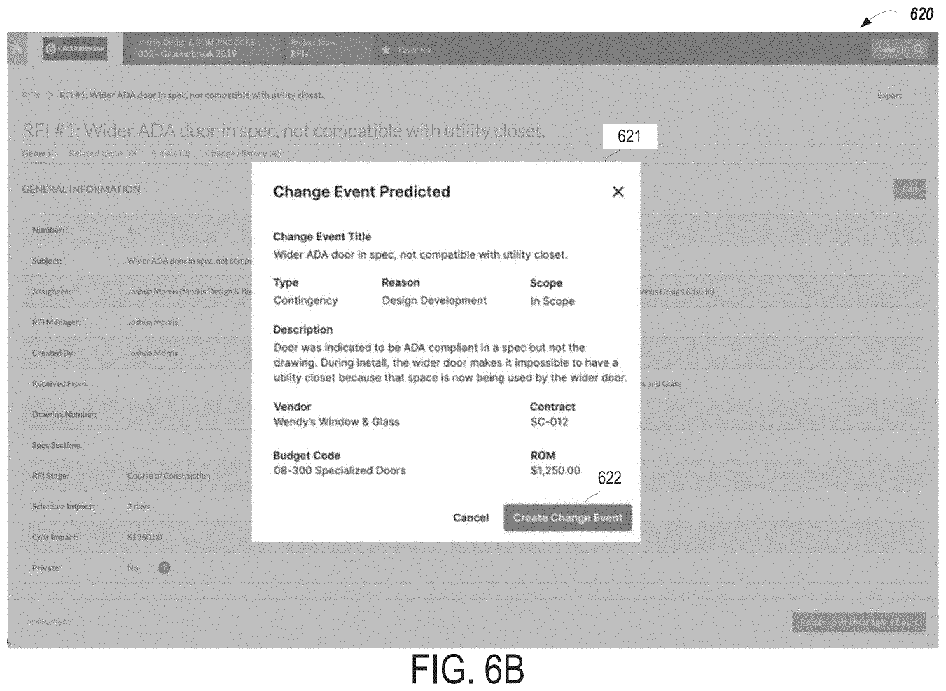

To illustrate with an example, FIG. 6A depicts an example GUI view 600 that may be displayed to a user for inputting data that defines a new RFI data item, such as the new RFI 610, that may then be received by the back-end computing platform and thereby initiate the example process 500 of FIG. 5. The view 600 may include a “General Information” section 611 that includes various fields for inputting information about the new RFI, such as: an “RFI #,” a “Subject,” a party designated as “RFI Manager,” a party that the RFI should be “Assigned To” for completion, a “Responsible Contractor,” a “Due Date” for completion of the RFI, a party that the RFI will be “Received From,” a “Distribution List” that identifies one or more parties to whom the RFI should be sent, a “Location” relevant to the RFI, “Drawing Number” for any drawings that are relevant to the RFI, a “Spec Section,” a relevant “Cost Code,” an anticipated “Schedule Impact,” an anticipated “Cost Impact,” a “Trade,” a “Reference,” and any “Related ACD/ASIs.”

The fields included in the GUI view 600 may take any of various forms. One or more fields may take the form of textboxes that enable the user to input numerical, alphabetical, and/or alphanumeric values. One or more fields may take the form of menus (e.g., drop-down menus, pop-up menus, etc.) that may display one or more options for the user to select a value that is to be input in the field(s). Various other examples are also possible.

Additionally, as shown in FIG. 6A, the example view 600 may include options for selecting whether the RFI should be tagged as a “Draft” or set to “Private.” As shown, these options may take the form of checkboxes, but other examples are also possible.

The example view 600 may additionally include a “Question” section 612 that enables the user to input questions, comments, and/or notes and an option for the user to “Attach File(s)” to upload information, such as documents, images, etc., that is to be included in or otherwise associated with the new RFI. Finally, the example view 600 may include options to discontinue inputting the data defining the new RFI and exit the view 600 by selecting a “Cancel” GUI button 613 or save the inputted data defining the new RFI by selecting a “Create” GUI button 614 and thereby cause the back-end computing platform to create the new RFI data item.

Certain fields may be designated as “required fields” that must be completed in order to create the new RFI data item. Such fields may be designated by a visual indication, such as an asterisk, as shown in FIG. 6A. In some implementations, it is possible that certain fields may be auto-populated by the back-end computing platform based on other data available to the back-end computing platform about the construction project (e.g., the “RFI #” field may be auto-populated sequentially, the “RFI Manager” field may be auto-populated with the project manager, the “Received From” field may be auto-populated with the name of the party that is creating the RFI, etc.).

It should be understood that the view 600 depicts only one example of a GUI view that may be presented to a user for creating a new RFI data item, and the GUI view may take various other forms, including various other fields not shown in FIG. 6A, and/or not include the fields shown in FIG. 6A. Other examples are also possible.

As shown in FIG. 6A, the user has started inputting data into some of the fields shown in the view 600. For instance, the user has inputted the value “1” in the “RFI #” field (or alternatively, this field may have been auto-populated by the back-end computing platform and presented to the user as a pre-filled field) and the value “Wider ADA door in spec, not compatible with utility closet.” in the “Subject” field. After completing inputting the data defining the RFI 610, the user may select the “Create” GUI button 614 to cause the back-end computing platform to receive the data and thus initiate creation of a new RFI data item for the RFI 610.

Returning to FIG. 5, at block 504, after receiving the data defining the new data item (and any related data items), the back-end computing platform may provide the data as input to the first software engine, which may take the form of the first software engine 300 of FIG. 3 as discussed above, and then run the first software engine based on that provided input. In line with the discussion above, running the first software engine may cause the first software engine to perform the functions discussed above and with reference to FIG. 3 in order to predict whether a new change event should be created based on the new data items.

At block 506, after running the first software engine based on the data defining the new data items, the back-end computing platform may evaluate the output of the first software engine, which may comprise an indication of whether or not a new change event should be created (and, if the output comprises a prediction that the new change event should be created, perhaps also any determined data about the new change event).

At block 508, based on the evaluation of the first software engine's output, the back-end platform may determine that creation of a new change event should be recommended. In turn, at block 510, the back-end computing platform may cause the client station to display a GUI view that includes a visual indication of the recommendation to create a new change event based on the new data items. This visual indication of the recommendation may take various forms. As one possibility, the visual indication of the recommendation may take the form of a pop-up notification or window that is overlaid onto a portion of the GUI view that indicates to the user that a new change event should be created. In some implementations, as discussed above, the visual indication of the recommendation may also include information about the new change event that should be created, such as a type of change event, a title, or a description for the change event. The information included in the visual indication may comprise information based on the data defining the new data item and/or other information available to the back-end computing platform.

Further, the GUI view may also include a selectable option to launch an interface to create the new change event using a software tool for creating and managing change events. In this respect, if the user wishes to create the new change event at that time, the user may select the option to launch the interface to create the new change event. Alternatively, if the user wishes to create the new change event at a later time, the user may access the software tool for creating and managing change events at a later time and then create the new change event at that later time.

To illustrate with an example, FIG. 6B depicts an example GUI view 620 that may be displayed to a user after the user has requested creation of the new data item for the RFI 610 as described above with reference to FIG. 6A. After receiving the data defining the RFI 610, the back-end computing platform may have input that data into the first software engine, which may have outputted a prediction that the RFI 610 warrants creation of a new change event. In turn, the back-end computing platform may have determined that creation of a new change event should be recommended to the user and thereby caused the view 620 to be displayed to the user.

As shown in FIG. 6B, the view 620 includes a visual indication 621 of a recommendation to create a new change event that takes the form of a pop-up window. In alternative implementations, the visual indication 621 may take other forms. The visual indication 621 may provide various information about the new change event that should be created, examples of which may include a title, a type, a reason for the change event, whether the change event is in scope or out of scope of an operative contract, an identification of the operative contract, a description, a vendor, a budget code, and a ROM that identifies a cost estimate for the change event. Furthermore, the visual indication 621 may include a selectable “Create Change Event” GUI button 622 that enables the user to launch a software tool for creating the recommended change event.

As shown in FIG. 6B, the visual indication 621 provides information that includes: a “Change Event Title” defined as “Wider ADA door in spec, not compatible with utility closet.” (which may be based on the “Subject” field value inputted by the user as described above with reference to FIG. 6A), a “Type” indicating “Contingency,” a “Reason” for the change event indicating “Design Development,” a “Scope” value indicating that the change event is “In Scope” based on an operative “Contract” identified as “SC-012,” a “Description” of the change event indicating that the “Door was indicated to be ADA compliant in a spec but not in the drawing. During install, the wider door makes it impossible to have a utility closet because that space is now being used by the wider door,” a “Vendor” identified as “Wendy's Window & Glass” who will likely be responsible for completing the work necessitated by the change event, a “Budget Code” for the change event identified as “08-300 Specialized Doors,” and a “ROM” indicating that the expected cost of the change event is “$1,250.00.” The user may then select a “Cancel” GUI button to forgo creating the recommended change event or alternatively select a “Create Change Event” GUI button 622 to launch a software tool for creating the recommended change event.

Returning to FIG. 5, as a result of the user selecting the option to launch the interface that is displayed at block 510, at block 512, the back-end computing platform may receive an indication of the user's selection. In turn, at block 514, the back-end computing platform may cause the client station to display the interface to create the new change event. Further, the back-end computing platform may auto-populate one or more data fields of the interface with any data that was determined at block 504 and thereby present that data as part of the data defining the new change event. To illustrate with the example discussed above with reference to FIG. 6B, the information about the recommended change event that was displayed to the user as part of the visual indication 621 may be used to auto-populate the data defining the new change event if the user selects the GUI button 622 to launch the software tool and create the new change event based on the recommendation provided by the visual indication 621. The user may then proceed to revise and/or enter additional data for the new change event, and then select an option to “Create” or “Save” the new change event, thereby causing the back-end computing platform to create and store a new data item for the new change event.

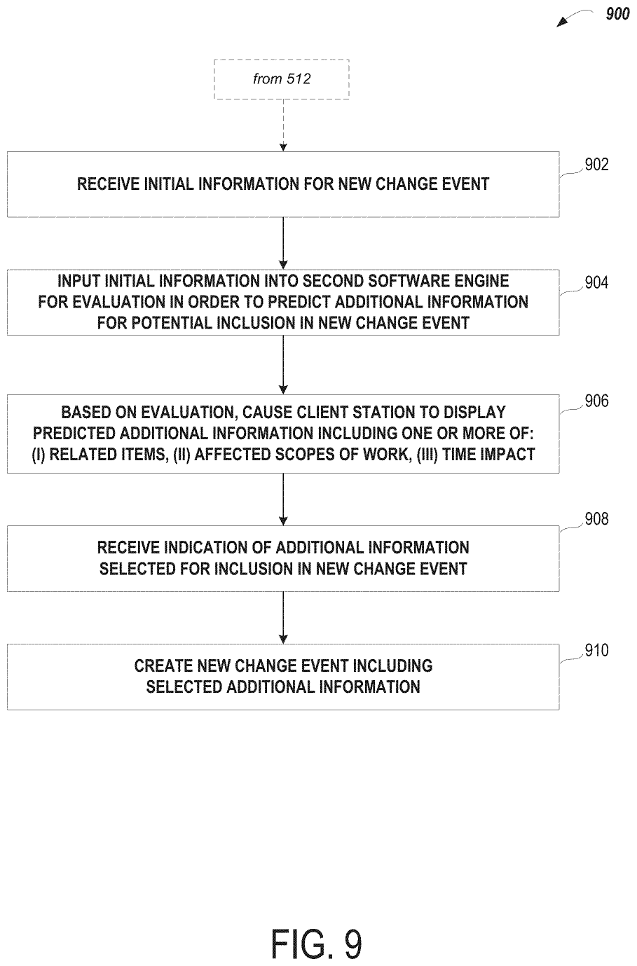

Optionally, in some implementations, as will be discussed in more detail further below with respect to FIG. 9, the back-end computing platform may run additional processes in accordance with the second aspect of the disclosed software technology for documenting change events.

Alternatively, in some implementations, after the first software engine has predicted at block 506 that a new change event should be created, the back-end computing platform may (i) display a selectable visual indication of a recommendation to create the new change event and an option to create the new change event, and (ii) after receiving an indication that the user has selected the option to create the new change event, automatically create the new change event based on the data items without presenting the user with the interface for creating the new change event.

b. Second Software Engine

According to a second aspect, the disclosed software technology comprises a second software engine that functions to (i) apply predictive analytics to a set of initial information for a new change event that is in the process of being created for a construction project in order to identify additional information for potential inclusion in the new change event and then (ii) facilitate creation of the new change event. For instance, after receiving a set of initial information for a new change event that is in the process of being created for a construction project, the second software engine may function to (i) apply predictive analytics to the set of initial information for the new change event in order to predict what additional information should potentially be included in the new change event, and then (ii) present a user with a recommendation of what additional information to potentially include in the new change event along with functionality that enables the user to select which additional information to add to the new change event being created.

At its core, the second software engine may comprise program code that functions to apply predictive analytics to an initial set of information for a new change event in order to identify additional information that may be included in the new change event. In this respect, in practice, the second software engine may include a respective set of program code for each different class of additional information that is to be identified by the second software engine. For example, the second software engine could comprise any of a first set of program code that functions to apply predictive analytics for predicting previously-created data items for the construction project that are potentially related to the new change event (which may be referred to herein as “related items” for the new change event), a second set of program code that functions to apply predictive analytics for predicting additional scopes of work that appear to be implicated by the new change event, a third set of program code that functions to apply predictive analytics for predicting likely impacts on the construction project's schedule, and so forth, among various other possibilities. Additionally, the second software engine may optionally include program code that functions to pre-process the set of initial information for a new change event before the predictive analytics are applied to the set of initial information. The second software engine may take various other forms as well.

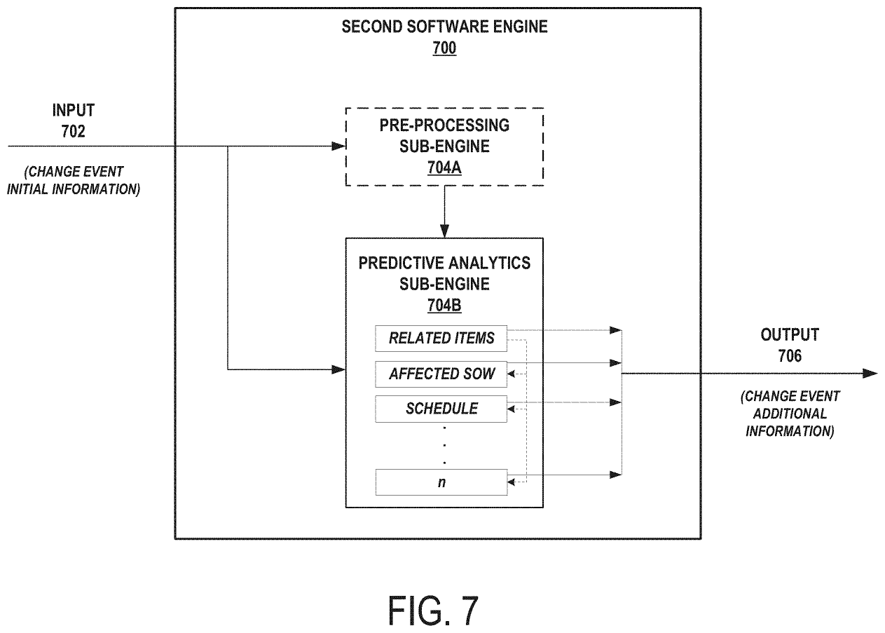

FIG. 7 illustrates one possible example configuration of the second software engine. As described above, the example second software engine 700 may be configured to receive, as input 702, a set of initial information for a new change event for a construction project. The set of initial information that is provided as input to and evaluated by the second software engine may take various forms. As one possibility, the set of initial information may include certain data that is input by a user via an interface for creating a new change event. Such data may include various types of information regarding the new change event. One example of such data may include textual information about the new change event that is being created (e.g., a title, a description, etc.). Another example of such data may include audiovisual information related to the new change event that is being created (e.g., an image, a video, and/or an audio clip). Yet another example of such data may include updated drawings for the construction project that are related to the new change event being created, and/or an updated building information modeling (BIM) model for the construction project that is related to the new change event being created. Other examples are also possible.

As another possibility, if the new change event is being created based on a recommendation that is presented to the user as a result of an output by the first software engine as described above, the set of initial information may include certain information for the new change event that has been determined by the first software engine. For instance, the data that is determined by the extraction sub-engine 304C as discussed above with reference to FIG. 3 may serve as part of the set of initial information that is evaluated by the second software engine when a user launches the interface to create a change events as discussed with reference to FIG. 5. Such determined data may take various forms, including, as some non-limiting examples, a predicted type of the new change event, a recommended title of the new change event, and/or a recommended description of the change event.

As yet another possibility, if the new change event is being created in response to a user's request to create the new change event based on another type of data item that was previously created for the construction project (e.g., by selecting an option to launch the interface for creating change events from within another software tool), the set of initial information may include certain information for the new change event that is automatically determined based on the data included in that other data item. For example, if a user decides to create a new change event based on an RFI data item that was previously created using an RFI software tool (e.g., by selecting a “Create Change Event” option within the “RFI” software tool), the set of initial information for the new change event may include certain information that is automatically extracted and/or derived from the data defining that RFI data item.

The set of initial information that is evaluated by the second software engine may take other forms as well.

After the set of initial information has been provided to the second software engine 700 as input 702, the input 702 may optionally be pre-processed by the sub-engine 704A to apply pre-processing techniques, which may involve any of the pre-processing techniques previously described. After any pre-processing is complete, the input 702 may pass to the predictive analytics sub-engine 704B. In implementations where the input 702 is not pre-processed, the input 702 may be provided directly to the predictive analytics sub-engine 704B. The predictive analytics sub-engine 704B may then apply predictive analytics to the input 702 in order to predict additional information that should potentially be included in the change event. After running the predictive analytics, the second software engine may yield an output 706, which may comprise a prediction of additional information that should potentially be included in or otherwise associated with the change event.

As noted above, the additional information that may be identified by the second software engine may include various classes of information. In order to identify the additional information, the second software engine may utilize various forms of predictive analytics, which may depend on the class of additional information that is to be identified.

As shown in FIG. 7, as one possibility, the additional information that is to be identified by the second software engine for potential inclusion in the new change event may include identifiers of related items for the new change event. In general, such related items may be any items that may be useful references for providing context to the new change event when the change event is being evaluated at a future time in order to determine if a consequent change order is required. Examples of such related items may include various types of previously-created data items, such as RFIs, drawings, documents, emails, observations, previous change events and/or change orders, conversations, tasks, and/or productivity logs, among other possibilities.

The predictive analytics that are utilized by the second software engine to identify related items for potential inclusion in the new change event may take various forms. As one example, such predictive analytics may take the form of a predictive model that leverages a construction knowledge graph that includes information about the relationships between the various data items that have been created for the construction project. Such a knowledge graph may include, for instance, data representing a given data item's respective relationship with each of one or more other data items. For example, in an instance where a new change event is being created based on a given RFI, the construction knowledge graph may indicate (i) that the given RFI, which refers to an object that is a door, is related to the door and consequently the door's physical location, (ii) that the door is related to a given cost estimate that includes the door as a line item, and (ii) that the cost estimate may thus also be associated with the door's physical location. As a result, the predictive model may determine, based on the construction knowledge graph, that the given RFI is related to the given cost estimate and may thus identify the given cost estimate as a related item for the new change event. Other examples of how the predictive model may leverage information provided by the construction knowledge graph for the construction project are also possible. More information about knowledge graphs and their use in identifying related items can be found in U.S. patent application Ser. No. 17,307,869, which was previously incorporated by reference above. Other examples of predictive analytics that may be utilized by the second software engine to identify related items are also possible.

After identifying related items for potential inclusion in the new change event, the second software engine may then output the data defining the related items as part of the output 706, based on which the back-end computing platform may cause the related items to be presented to the user in a manner that enables the user to select one or more related items to identify within and/or otherwise associate with the new change event that is being created, which may provide several advantages. One such advantage is that the identified related item(s) may provide additional context for the change event and enable easy access to the related item(s) when the change event is viewed later (e.g., when a user is evaluating whether to include the change event in a new change order for the construction project), which may improve the user experience of individuals tasked with creating change orders. Another such advantage is that associating the change event with other related items may improve the accuracy of the predictive analytics that are applied to identify any additional scopes of work, as discussed below. Other advantages may exist as well.

As another possibility, the additional information that may be identified by the second software engine for potential inclusion in the new change event may include any additional scopes of work that appear to be implicated by the new change event. Each such additional scope of may be defined in terms of a categorization of the additional scope of work (e.g., a budget code or the like), an indication of at least one company (e.g., a contractor, supplier, vendor, etc.) that would be tasked with performing the additional scope of work (perhaps along with an indication of the operative contract for the company), and an estimate of the cost that would be required to complete the additional scope of work, among other possible types of information. Each additional scope of work may include other types of information as well.

After identifying the additional scopes of work that should potentially be included in the new change event, the second software engine may include data defining the additional scopes of work in the output 706, based on which the back-end computing may then cause the additional scopes of work to be presented to the user in a manner that enables the user to select one or more of the identified additional scopes of work to be added as respective change event line items for the new change event that is being created.

The predictive analytics that may be utilized by the second software engine to predict which additional scopes of work should be included in the new change event may take any of various forms. For instance, in one possible implementation, the second software engine may predict which scopes of work should be included in the new change event using a combination of a classification model for predicting the categories of additional work activities that are most likely implicated by the new change event, data indicating a category-by-category breakdown of which companies handle work activities on the construction project, and one or more models for estimating the cost of the additional work activities in the predicted categories. In such an implementation, the classification model may be trained using a machine learning process and may function to (i) receive, as input, the set of initial information for the new change event (and perhaps also any identified related items as described above), (ii) evaluate the set of initial information for the new change event (and perhaps also the identified related items as described above), and (iii) based on the evaluation, predict which one or more categories of additional work activities are most likely implicated by the new change event. After the classification model predicts the one or more categories of additional work activities, then for each predicted category of additional work activity, the second software engine may (i) use data indicating a category-by-category breakdown of which companies handle work activities on the construction project to determine which one or more companies are most likely to perform the additional work activity in the predicted category and (ii) use one or more models to estimate a cost of the additional work activity in the predicted category. Each predicted category of additional work activity, along with the corresponding company and estimated cost that is predicted for that category, may then be identified as one scope of work that should potentially be included in the new change event. Additionally, in some implementations, the second software engine may also use data representing the operative contract related to each identified scope of work in order to predict any expected costs related to the identified scope of work and whether those costs would be considered within the scope of the operative contract or outside the scope of the operative contract (which then dictates who would be responsible for paying for the identified scope of work if the change event were elevated to a change order).

In practice, the classification model that may be used by the second software engine may be created by a back-end computing platform, which may be, for example, the computing platform 200 described above. The process of creating the classification model that may be used by the second software engine to predict the one or more additional scopes of work implicated by a new change event may take any of various forms.

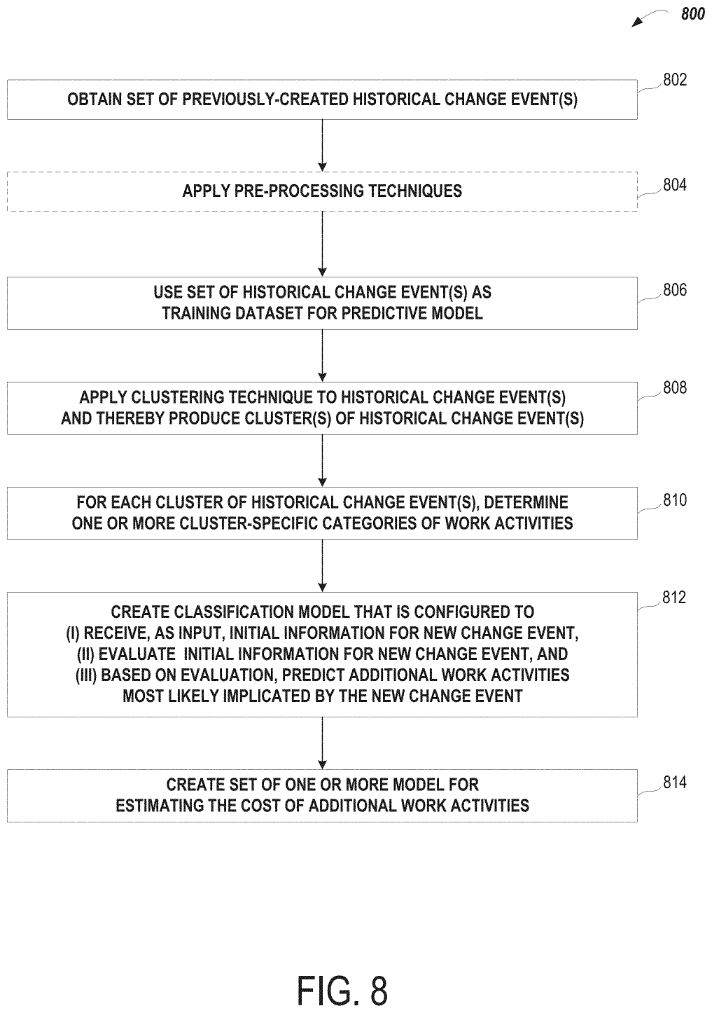

One possible example of a process for creating the classification model that may be used by the second software engine to predict the one or more additional scopes of work implicated by a new change event is illustrated in FIG. 8. In such an implementation, the back-end computing platform may begin at block 802 by obtaining a set of one or more historical change event data items that were previously created for one or more construction projects managed using a construction management software application. Each such historical change event data item may include data defining the change event, including general information about the change event, such as a title, a description, notes regarding the change event, etc., as well as one or more change event line items that define one or more scopes of work and/or work activities that were implicated by the change event.

After obtaining the set of historical change event data item(s), the back-end computing platform may, at block 804, optionally apply one or more pre-processing techniques, such as one or more of the NLP techniques discussed above, to increase the suitability of the set of historical change event data item(s) for use as training data for a machine learning process that is then used to predict additional information for a new change event that is being created.

After optionally pre-processing the data defining the set of historical change event data items, at block 806, the back-end computing platform may use the set of historical change event items as a training dataset for a machine learning process that functions to train the classification model that is configured to (i) receive, as input, the set of initial information for the new change event (and perhaps also the related items identified as described above), (ii) evaluate the set of initial information for the new change event (and perhaps also the related items identified as described above), and (iii) based on the evaluation, predict which one or more categories of additional work activities are most likely implicated by the new change event. This machine learning process may take various forms.

One possible implementation of such a machine learning process is illustrated at blocks 808-814. In such an implementation, the machine learning process may begin at block 808 by applying a clustering technique that clusters the historical change event data items in the set based on certain information about each historical change event items (e.g., title, description, etc.) and thereby produces a set of one or more “clusters” of historical change event data items, where the change event data items in each given cluster have similar characteristics to one another.

Next, at block 810, for each identified cluster of historical change event data items, the machine learning process may use respective change event line item information for each historical change event data item within the cluster to determine a set of one or more categories of work activities that are associated with the cluster (i.e., a cluster-specific set of one or more categories of work activities). The cluster-specific set of one or more categories of work activities that are associated with a given cluster (e.g., a cluster defined by historical change event data items having similar budget codes) may take various forms and be determined in various manners.

As one possibility, a cluster-specific set of one or more categories of work activities associated with a given cluster may comprise a superset of all of the categories of work activities that are included in the different historical change event data items within the cluster. As another possibility, a cluster-specific set of one or more categories of work activities associated with a given cluster may comprise those categories of work activities that are included in a threshold proportion of the historical change event data items within the cluster (e.g., categories of work activities that are included in at least 50% of the historical change event data items within the cluster), in which case the machine learning process may (i) determine, on a category-by-category basis, a given proportion of historical change event data items in the cluster that included at least one work activity in a respective category of work activities and then, (ii) if the determined proportion exceeds the threshold proportion (e.g., 50%), identify the respective category of work activities as a category of work activities that is commonly associated with the cluster of historical change event data items. Other possibilities also exist.

In some implementations, a cluster-specific set of categories of work activities associated with a given cluster may also be broken down into different subsets that correspond to different confidence levels. For example, a cluster-specific set of categories of work activities associated with a given cluster may include a first subset of categories that have a high likelihood of being included in historical change event data items within the cluster (e.g., categories that appear in at least 75% of the historical change event data items within the cluster), a second subset of categories that have an intermediate likelihood of being included in historical change event data items within the cluster (e.g., categories that appear in between 50% and 75% of the historical change event data items within the cluster), and a third subset of categories that have a low likelihood of being included in historical change event data items within the cluster (e.g., categories that appear in less than 50% of the historical change event data items within the cluster). This sub-categorization of the categories of work activities associated with the given cluster may then enable the classification model to group the predicted categories of work activities that are implicated by a new change event item into different “tiers,” which may then be incorporated into the presentation of the predicted additional scopes of work for the new change event. For example, different colors may be used to indicate the different tiers of the predicted additional scopes of work for the new change event (e.g., green text or highlighting for additional scopes of work having a high likelihood of being implicated, yellow text or highlighting for additional scopes of work having an intermediate likelihood of being implicated, and red text or highlighting for additional scopes of work having a low likelihood of being implicated, etc.). Other examples are also possible.

After applying clustering techniques as described above, at block 812, the back-end computing platform may then embody the clusters and the determined cluster-specific sets of categories of work activities for the clusters into a classification model that functions to (i) receive a set of initial information for a new change event, (ii) based on the received set of initial information, classify the new change event into a given cluster, and then (iii) predict one or more categories of work activities implicated by the new change event based on the determined cluster-specific set categories of work activities for the given cluster. As previously mentioned, the predicted one or more categories of work activities may be represented in various ways, such as in terms of one or more budget codes, among other possibilities.

Alternatively, as another possible implementation, instead of determining a single, cluster-specific set of one or more categories of work activities that are associated with each cluster of historical change event data items, the back-end computing platform may place each respective cluster of historical change event data items through a second clustering process that sub-clusters the historical change event data items within the respective cluster based on their change event line item information and thereby produces a respective set of sub-clusters for the respective cluster, where the historical change event data items within each given sub-cluster include change event line items directed to a common set of one or more categories of work activities (i.e., a sub-cluster-specific set of one or more categories of work activities). The back-end computing platform may then embody these sub-clusters into a classification model that functions to (i) receive a set of initial information for a new change event, (ii) based on the received set of initial information, classify the new change event into a given cluster, and then (iii) predict that the one or more categories of work activities implicated by the new change event will comprise one of the sub-cluster-specific sets of one or more categories of work activities, where the different sub-cluster-specific sets of one or more categories of work activities can then be presented as different options for selection by a user.

As yet another possible implementation, the back-end computing platform may run the clustering process multiple times using different clustering techniques, which may cluster the set of historical change event data items in different ways and thereby produce multiple different sets of “clusters” of historical change event data items. Then, for each different set of clusters, the back-end computing platform may perform the same functions described above to create a different classification model from each different set of clusters (where the prediction of the one or more categories of work activities implicated by the new change event may differ from model to model). The back-end computing platform may then combine the multiple different classification models into a single ensemble classification model that takes each classification model's individual prediction of the one or more categories of work activities implicated by the new change event and then makes a single, overall prediction of the one or more categories of work activities implicated by the new change event. The logic used by the ensemble classification model to make the overall prediction of the one or more categories of work activities implicated by the new change event may take various forms. As one possibility, the one or more categories of work activities implicated by the new change event may comprise a superset of all of the categories of work activities that are predicted by each of the different classification models. As another possibility, the one or more categories of work activities implicated by the new change event may comprise one or more categories of work activities that were predicted by a threshold proportion (e.g., 50%) of the different classification models. Other examples are also possible.

After creating the one or more classification models to predict the one or more categories of work activities as described above, at block 814, the back-end computing platform may then create a set of one or more models for estimating the cost of the additional work activities in each possible category of work activities. The one or more models for estimating the cost of the additional work activities—and the techniques utilized to create such models—may take any of various forms.

As one possibility, the back-end computing platform may use statistical techniques to create a set of one or more statistical models for estimating the cost of the additional work activities in each possible category of work activities. In this respect, a statistical model for a given category of work activity may provide an indication of a most-likely cost for performing a work activity in the given category, which may be represented in terms of a single estimated cost (e.g., a median, mean, or the like), a range of estimated costs (e.g., some number of standard deviations above or below a median cost), or multiple discrete options for the estimated cost (e.g., in a scenario where the historical cost data is multimodal). The function of creating the set of one or more statistical models may take various forms.

In one implementation, the set of one or more statistical models may be defined on a cluster-by-cluster basis for each of the commonly-included categories of work activities for each identified cluster of historical change event data items described above. For instance, for each of the commonly-included categories of work activities for a given cluster of historical change event data items, the back-end computing platform may (i) compile all of the change event line items directed to work activities in the commonly-included category, (ii) extract the estimated cost information for the change event line items, and then (iii) apply one or more statistical techniques to that estimated cost information in order to derive a cluster-specific statistical model for estimating the cost of a work activity in that commonly-included category. As mentioned, such a statistical technique may involve calculating a median, mean, or the like, calculating one or more standard deviations above and/or below the mean, and/or perhaps identifying multiple different modalities within the estimated cost information, among other possibilities. Thereafter, when the classification model classifies a new change event into a given cluster, the second software engine may use the cluster-specific statistical model for each of the commonly-included categories of work activities for the given cluster in order to estimate the cost of each predicted category of work activity implicated by the new change event.

In another implementation, the one or more statistical models may be defined across multiple different clusters instead of being defined on a cluster-specific basis. For instance, for each of the commonly-included categories of work activities for multiple different clusters of historical change events, the back-end computing platform may (i) compile all of the line items directed to work activities in the category, (ii) extract the estimated cost information for the change event line items, and then (ii) apply one or more statistical techniques to that estimated cost information in order to derive a category-specific statistical model for estimating the cost of a work activity in that commonly-included category across all of the multiple different clusters. Advantageously, this approach may provide a larger universe of change event line items for a given category of work activity that can be used to create the one or more statistical models.

As another possibility, the back-end computing platform may use a machine-learning technique (e.g., regression, neural networks, etc.) to create a set of one or more predictive models for estimating the cost of the additional work activities in each possible category of work activities. For instance, for each of at least a subset of the work activity categories, the back-end computing platform may (i) compile all of the change event line items directed to work activities in that category, (ii) label the change event line items with cost information, and then (iii) apply a machine-learning technique to the labelled change event line items in order to train a predictive model to estimate the cost of a work activity in that category based on certain features associated with the work activity.

To illustrate with an example, such a predictive model could be trained to estimate the cost of a paint job based on features that include the square footage of area to be painted, among other possible features.

The one or more models for estimating the cost of the additional work activities—and the techniques utilized to create such models—may take other forms as well.

Returning to FIG. 7, as yet another possibility, the additional information that may be identified by the second software engine for potential inclusion in the new change event may include an indication of how the construction project's schedule is likely to be impacted by the new change event. For instance, as one possible implementation, the second software engine may function to (i) evaluate whether any of the identified additional scopes of work impact activities along a “critical path” of the construction project (e.g., the longest sequence of tasks that must be completed to successfully conclude the construction project), and then (ii) if so, apply predictive analytics to estimate an amount of time by which the construction project is likely to be delayed as a result of the identified scopes of work.

In this respect, the predictive analytics that may be utilized by the second software engine to identify such determined impacts to the critical path could take the form of a predictive model that is trained using a machine learning process and functions to (i) receive, as input, the identified additional scopes of work and the current schedule for the construction project, (ii) evaluate each identified additional scope of work vis-à-vis the critical path of the construction project, and (iii) based on the evaluation, predict an amount of delay that each identified scope of work is likely to introduce into the critical path (which could be a zero delay for identified scopes of work that do not impact the critical path and a non-zero delay for identified scopes of work that do impact the critical path). This machine learning process may employ any of various machine learning techniques, including but not limited to regression, neural networks, and/or clustering, among various other possibilities. Likewise, the predictive model may be configured to extract various features as part of its evaluation, examples of which may include the activities that are impacted and/or the item(s) that are impacting such activities, among other possibilities.

Information regarding any scheduling impacts identified by the second software engine, such as critical activities and consequent timing delays and/or cost impacts, may then be included as part of the data defining the change event and presented to the user, which may provide several advantages. One such advantage may be that the identified scheduling impacts may provide additional context that may aid the user in deciding which identified scopes of work to add as line items for the change event and thereby include as part of the data defining the change event.

The additional information that may be identified by the second software engine may include various other types of information as well.

After the second software engine identifies the additional information that should potentially be included in the new change event as described above, the second software engine may output data comprising the additional information. In turn, the back-end computing platform may cause the identified additional information to be presented to the user in a manner that enables the user to select certain information that the user wishes to include in or otherwise associate with the change event. For instance, the back-end computing platform may cause the user's client station to display a GUI view that includes (i) a set of one or more selectable GUI elements (e.g., buttons, icons, links, etc.) representing any identified related items, (ii) a set of one or more selectable GUI elements representing any identified affected scopes of work, and/or (iii) a visual representation of any identified scheduling delays. The user may then select one or more related items and/or one or more affected scopes of work to include in the change event. After selecting the related items and affected scopes of work to include in the change event, the user may then select an option to “Save” or “Create” the change event, which may in turn cause the back-end computing platform to create a data item for the new change event.

In an alternative implementation, after the second software engine identifies the additional information that should potentially be included in the new change event, the back-end computing platform may automatically create the data item for the new change event, including at least some of the additional identified additional information (e.g., information for which there is a threshold level of confidence that such information should be included in the new change event), without input from the user requesting creation of the new change event.

Regardless, after the new change event has been created, it may be accessible to other users and may be evaluated for potential inclusion in a future change order, among other possible uses of the change event.

With reference now to FIG. 9, an example process for predicting additional information that should potentially be included in a new change event according to the second aspect of the disclosed software technology is shown. In practice, the example process 900 may begin at block 902, where a back-end computing platform that is running a software application incorporating the disclosed technology receives, via a GUI displayed at a client station associated with a user, initial information for a new change event for a given construction project. As described above, such initial information may take various forms, including user-inputted data defining the change event, data determined by the first software engine, and/or data defining a data item from which the change event interface was launched.

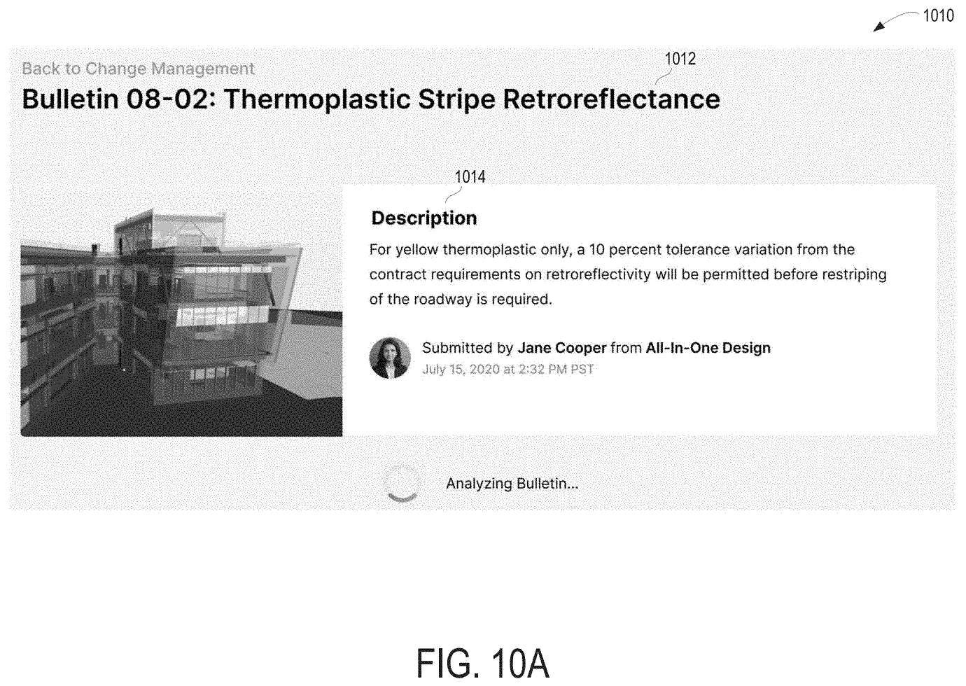

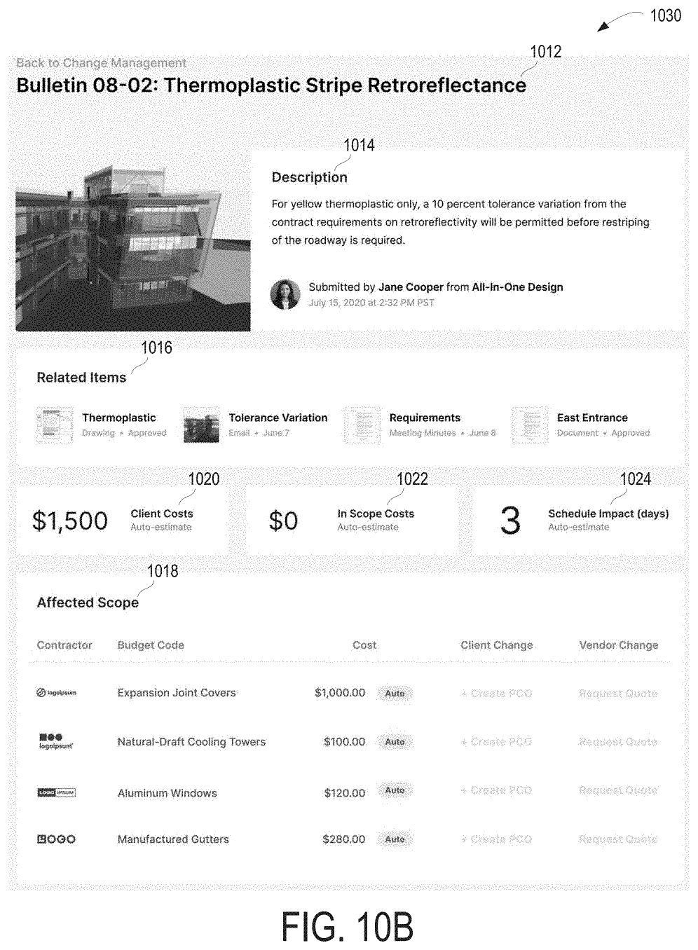

To illustrate with an example, FIG. 10A depicts an example GUI view 1010 that may be presented to a user after the back-end computing platform has received data defining a new change event and initiated the process discussed above with respect to block 902 of FIG. 9. In the example shown in FIG. 10A, the user may have requested creation of a new change event 1012 titled “Bulletin 08-02: Thermoplastic Stripe Retroreflectance” after being presented with a GUI view for inputting data defining the change event 1012 (which may have been presented to the user based on selecting an option to launch a change event creation tool based on a recommendation provided by the back-end computing platform to create the change event 1012 as described above with reference to FIG. 5) and then selecting an option to save the inputting data and cause the back-end computing platform to receive the data and create the new change event 1012.

As shown in FIG. 10A, the data defining the change event 1012 may include a description 1014 indicating “For yellow thermoplastic only, a 10 percent tolerance variation from the contract requirements on retroreflectivity will be permitted before restriping of the roadway is required.” The data defining the change event 1012 may also include information about a party “Jane Cooper” that submitted the request to create the change event 1012, and a date and time when the request was submitted. Together, the information about the change event shown in view 1010 may comprise some or all of a set of initial information that is provided by the back-end computing platform as input to the second software engine for predicting additional information that should potentially be included in the change event. While the second software engine is initiating or in the process of evaluating the initial information as previously described above, the view 1010 may be updated to display an indication notifying the user that an analysis is underway. The indication may take various forms, some examples of which may include a textual indication, a graphic indication, or a combination of the two. As shown in FIG. 10A, the view 1010 includes an indication comprising a textual label reading “Analyzing Bulletin” that is accompanied by a “loading” graphic, thereby indicating to the user that the back-end computing platform has received the data defining the change event 1012 and has initiated an evaluation of that data.

Returning to FIG. 9, after receiving the set of initial information for the new change event, the back-end computing platform may, at block 904, provide the initial information as input to the second software engine, which may take the form of the second software engine 700 of FIG. 7, and then run the second software engine based on that input. In line with the discussion above, running the second software engine may cause the second software engine to perform the functions discussed above and with reference to FIG. 8 in order to predict additional information that should potentially be included in the new change event, such as related items, affected scopes of work, and/or scheduling impacts. The second software engine may then provide any predicted additional information as output, which may then be evaluated by the back-end computing platform.

After the second software engine has yielded an output of the predicted additional information, the back-end computing platform may evaluate the output and cause the additional information (or at least a subset of that additional information) to be presented to the user in a manner that is selectable. This view may take various forms. Based on an evaluation of the second software engine's output, at block 906, the back-end computing platform may then cause the user's client station to display a GUI view that includes visual representations of one or more classes of predicted additional information that may be selectable by the user to include in or otherwise associate with the change event being created.

To illustrate with an example, FIG. 10B depicts an example GUI view 1030 that may be presented to the user after the second software engine has predicted one or more classes of additional information for potential inclusion in the change event 1012 of FIG. 10A. For example, the software engine may have predicted one or more related items for the change event 1012. Therefore, as shown in FIG. 10B, the view 1030 may include a “Related Items” section 1016 that includes respective selectable visual representations for each predicted related item. Further, the second software may have predicted one or more affected scopes for the change event 1012. Therefore, as shown in FIG. 10B, the view 103 may include an “Affected Scope” section 1018 that includes respective selectable visual representations for each “Affected Scope” line item. Further, the view 1030 may include a representation of the total expected costs of the predicted affected scopes and an indication of the party that is responsible for paying those costs based on an operative contract that the second software engine may have evaluated as part of the predictive analytics process. For example, as shown in FIG. 10B, a visual representation 1020 for “Client Costs” may depict an amount of $1,500, and a visual representation 1022 for “In Scope Costs” may depict an amount of $0, indicating that the total expected costs of $1,500.00 are outside the scope of the operative contract that was evaluated for this change event. Still further, the view 1030 may include an indication of an expected schedule delay that may occur as a result of the change event. As shown in FIG. 10B, a visual representation 1024 for “Schedule Impact” indicates that the change event 1012 will likely cause an estimated 3-day delay to the construction project's schedule.

After being presented with the view 1030, the user may then select each respective selectable visual representation of additional information that the user wishes to include in the change event. For example, the user may select one, some, or all of the Related Items 1016 and/or one, some, or all of the Affected Scopes 1018 to include in the change event. Although not shown in FIG. 10B, the user may also be presented with a selectable option to “Save” and/or “Create” the new change event that, when selected, may prompt the back-end platform to create the change event, after which the change event may be available for review and inclusion in a change order that formalizes a change to the construction project's overall scope of work.

Returning to FIG. 9, at block 908, the back-end computing platform may receive an indication of each additional information that was selected by the user for inclusion in the change event. The back-end computing platform may additionally receive an indication that the user has selected an option to “Save” and/or “Create” the new change event. Thereafter, at block 910, the back-end computing platform may create the new change event and store the data defining the change event, including the selected additional information that was selected by the user for inclusion in the change event.

After the change event has been created, it may be available for subsequent inclusion in a change order that formalizes a change to the construction project's overall scope of work.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” “parties,” or other entities, this is for purposes of example and explanation only. Claims should not be construed as requiring action by such actors unless explicitly recited in claim language.

1. A computing system comprising:
a network interface;
at least one processor;
a non-transitory computer-readable medium; and
program instructions stored on the non-transitory computer-readable medium that are executable by the at least one processor such that the computing system is configured to:
receive, from a client station associated with a user, a request to create a new change event for a construction project;
obtain a set of initial information about the new change event;
evaluate the set of initial information about the new change event using predictive analytics and thereby predict one or more scopes of work that are likely implicated by the new change event, wherein each of the one or more scopes of work comprises a category of work activity and an estimated cost of performing the work activity;
cause the client station to present the one or more scopes of work that are likely implicated by the new change event;
receive, from the client station, data indicating that the user has selected at least one given scope of work from the one or more scopes of work; and
create a data item that represents the new change event and includes data defining the at least one given scope of work selected by the user.

2. The computing system of claim 1, wherein the set of initial information about the new change event comprises one or more of: (i) information about the new change event that was inputted by the user via an interface for creating the new change event or (ii) information determined based on information about at least one other data item that is related to the new change event.

3. The computing system of claim 1, wherein each of the one or more scopes of work further comprise a respective identification of a company that is likely to perform the work activity.

4. The computing system of claim 1, wherein the program instructions that are executable by the at least one processor such that the computing system is configured to evaluate the set of initial information about the new change event using the predictive analytics comprise program instructions that are executable by the at least one processor such that the computing system is configured to:
input the set of initial information about the new change event into a classification model that is trained using a clustering technique and is configured to predict one or more categories of work activities that are most likely implicated by the new change event; and
for each predicted category of work activity, (i) identify a company that is likely to perform the work activity; and (ii) use at least one model to determine an estimated cost of the work activity.

5. The computing system of claim 1, wherein the predictive analytics that are used to evaluate the set of initial information about the new change event comprise first predictive analytics, and wherein the computing system further comprises program instructions stored on the non-transitory computer-readable medium that are executable by the at least one processor such that the computing system is configured to:
before receiving the request to create the new change event for the construction project:
evaluate information about at least one other data item that has previously been created for the construction project using second predictive analytics and thereby predict that the new change event should be created based on the at least one other data item; and
cause the client station to present a recommendation to create the new change event based on the at least one other data item, wherein the request to create the new change event for the construction project comprises data indicating that the user has accepted the recommendation to create the new change event based on the at least one other data item.

6. The computing system of claim 5, wherein the program instructions that are executable by the at least one processor such that the computing system is configured to evaluate the information about the at least one other data item that has previously been created using the second predictive analytics comprise program instructions that are executable by the at least one processor such that the computing system is configured to:
input the information about the at least one other data item that has been previously created into a classification model that is trained using a clustering technique and is configured to predict whether or not a new change event should be created based on the at least one other data item.

7. The computing system of claim 5, wherein the set of initial information comprises information that is determined based on information about the at least one other data item.

8. The computing system of claim 5, wherein the at least one other data item comprises a given data item that was most recently created by the user for the construction project.

9. The computing system of claim 8, wherein the at least one other data item further comprises one or more additional data items that were determined to be related to the given data item.

10. The computing system of claim 1, wherein the predictive analytics that are used to evaluate the set of initial information about the new change event comprise first predictive analytics, and wherein the computing system further comprises program instructions stored on the non-transitory computer-readable medium that are executable by the at least one processor such that the computing system is configured to:
evaluate the set of initial information about the new change event using second predictive analytics and thereby predict one or more previously-created data items for the construction project that are likely related to the new change event;
cause the client station to present the one or more previously-created data items that are likely related to the new change event;
receive, from the client station, data indicating that the user has selected at least one given previously-created data item from the one or more previously-created data items; and
include, in the data item that represents the new change event, data identifying the at least one previously-created data item selected by the user.

11. The computing system of claim 1, wherein the predictive analytics that are used to evaluate the set of initial information about the new change event comprise first predictive analytics, and wherein the computing system further comprises program instructions stored on the non-transitory computer-readable medium that are executable by the at least one processor such that the computing system is configured to:
evaluate the one or more scopes of work that are likely implicated by the new change event using second predictive analytics and thereby predict a schedule delay that is likely to occur as a result of the new change event; and
cause the client station to present a representation of the schedule delay that is likely to occur as a result of the new change event.

12. A non-transitory computer-readable medium, wherein the non-transitory computer-readable medium is provisioned with program instructions that, when executed by at least one processor, cause a computing system to:
receive, from a client station associated with a user, a request to create a new change event for a construction project;
obtain a set of initial information about the new change event;
evaluate the set of initial information about the new change event using predictive analytics and thereby predict one or more scopes of work that are likely implicated by the new change event, wherein each of the one or more scopes of work comprises a category of work activity and an estimated cost of performing the work activity;
cause the client station to present the one or more scopes of work that are likely implicated by the new change event;
receive, from the client station, data indicating that the user has selected at least one given scope of work from the one or more scopes of work; and
create a data item that represents the new change event and includes data defining the at least one given scope of work selected by the user.

13. The non-transitory computer-readable medium of claim 12, wherein the set of initial information about the new change event comprises one or more of: (i) information about the new change event that was inputted by the user via an interface for creating the new change event or (ii) information determined based on information about at least one other data item that is related to the new change event.

14. The non-transitory computer-readable medium of claim 12, wherein each of the one or more scopes of work further comprise a respective identification of a company that is likely to perform the work activity.

15. The non-transitory computer-readable medium of claim 12, wherein the program instructions that, when executed by at least one processor, cause the computing system to evaluate the set of initial information about the new change event using the predictive analytics comprise program instructions that, when executed by at least one processor, cause the computing system to:
input the set of initial information about the new change event into a classification model that is trained using a clustering technique and is configured to predict one or more categories of work activities that are most likely implicated by the new change event; and
for each predicted category of work activity, (i) identify a company that is likely to perform the work activity; and (ii) use at least one model to determine an estimated cost of the work activity.

16. The non-transitory computer-readable medium of claim 12, wherein the predictive analytics that are used to evaluate the set of initial information about the new change event comprise first predictive analytics, and wherein the non-transitory computer-readable medium is also provisioned with program instructions that, when executed by at least one processor, cause a computing system to:
before receiving the request to create the new change event for the construction project:
evaluate information about at least one other data item that has previously been created for the construction project using second predictive analytics and thereby predict that the new change event should be created based on the at least one other data item; and
cause the client station to present a recommendation to create the new change event based on the at least one other data item, wherein the request to create the new change event for the construction project comprises data indicating that the user has accepted the recommendation to create the new change event based on the at least one other data item.

17. The non-transitory computer-readable medium of claim 16, wherein the program instructions that, when executed by at least one processor, cause the computing system to evaluate the information about the at least one other data item that has previously been created using the second predictive analytics comprise program instructions that, when executed by at least one processor, cause the computing system to:
input the information about the at least one other data item that has been previously created into a classification model that is trained using a clustering technique and is configured to predict whether or not a new change event should be created based on the at least one other data item.

18. The non-transitory computer-readable medium of claim 12, wherein the predictive analytics that are used to evaluate the set of initial information about the new change event comprise first predictive analytics, and wherein the non-transitory computer-readable medium is also provisioned with program instructions that, when executed by at least one processor, cause a computing system to:
evaluate the set of initial information about the new change event using second predictive analytics and thereby predict one or more previously-created data items for the construction project that are likely related to the new change event;
cause the client station to present the one or more previously-created data items that are likely related to the new change event;
receive, from the client station, data indicating that the user has selected at least one given previously-created data item from the one or more previously-created data items; and
include, in the data item that represents the new change event, data identifying the at least one previously-created data item selected by the user.

19. A method carried out by a computing system, the method comprising:
receiving, from a client station associated with a user, a request to create a new change event for a construction project;
obtaining a set of initial information about the new change event;
evaluating the set of initial information about the new change event using predictive analytics and thereby predict one or more scopes of work that are likely implicated by the new change event, wherein each of the one or more scopes of work comprises a category of work activity and an estimated cost of performing the work activity;
causing the client station to present the one or more scopes of work that are likely implicated by the new change event;
receiving, from the client station, data indicating that the user has selected at least one given scope of work from the one or more scopes of work; and
creating a data item that represents the new change event and includes data defining the at least one given scope of work selected by the user.

20. The method of claim 19, wherein the set of initial information about the new change event comprises one or more of: (i) information about the new change event that was inputted by the user via an interface for creating the new change event or (ii) information determined based on information about at least one other data item that is related to the new change event.
